(19) United States
(12) Patent Application Publication
(10) Pub. No.: US 2023/0224965 A1
(43) Pub. Date: Jul. 13, 2023

(54) TIME-DIVISION MULTIPLE ACCESS (TDMA)-BASED BAND RESERVATION

(71) Applicant: QUALCOMM Incorporated, San Diego, CA (US)

(72) Inventors: Stelios STEFANATOS, San Diego, CA (US); Shuanshuan WU, San Diego, CA (US); Arthur GUBESKYS, San Diego, CA (US)

(21) Appl. No.: 18/000,483

(22) PCT Filed: Jun. 23, 2021
(86) PCT No.: PCT/US2021/038751

§ 371 Date: Dec. 1, 2022

(30) Foreign Application Priority Data
Jun. 24, 2020 (GR) 20200100366

(51) Int. Cl. H04W 74/08

(52) U.S. Cl. CPC H04W 74/0816; H04W 16/14

(57) ABSTRACT

Certain aspects of the present disclosure provide techniques for sidelink communications in an unlicensed spectrum. A method that may be performed by a first user equipment (UE) of a plurality of UEs includes sensing a frequency band to determine whether the frequency band is idle, the sensing occurring prior to a first time period. In some examples, the method may include transmitting, by the first UE, one or more signals over the frequency band during the first time period based on determining that the frequency band is idle, the one or more signals indicating that the frequency band is reserved for wireless communication between the plurality of UEs during the first time period.

### CROSS-REFERENCE TO RELATED APPLICATION(S)

This application claims benefit of and priority to Greek Patent Application No. 20200100366, filed Jun. 24, 2020, which is hereby assigned to the assignee hereof and hereby expressly incorporated by reference herein in its entirety as if fully set forth below and for all applicable purposes.

### INTRODUCTION

Aspects of the present disclosure relate to wireless communications, and more particularly, to techniques for resource reservation for wireless communication.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims, which follow, some features will now be discussed briefly.

Certain aspects relate to a method of wireless communication. In some examples, the method includes sensing, by a first user equipment (UE) of a plurality of UEs, a frequency band to determine whether the frequency band is idle, the sensing occurring prior to a first time period. In some examples, the method includes transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

Certain aspects relate to a first user equipment (UE) of a plurality of UEs. The first UE may include a memory; and a processor coupled to the memory. In some examples, the processor and the memory are configured to sense a frequency band to determine whether the frequency band is idle, the sensing occurring prior to a first time period. In some examples, the processor and the memory are configured to transmit one or more signals over the frequency band during the first time period based on determining that the frequency band is idle, the one or more signals indicating to one or more other wireless devices, configured to communicate using a different wireless technology than the plurality of UEs, that the frequency band is busy during the first time period, the one or more signals further indicating that the frequency band is reserved for wireless communication between the plurality of UEs during the first time period.

Certain aspects relate to an apparatus for wireless communication. In some examples, the apparatus includes means for sensing, by a first user equipment (UE) of a plurality of UEs, a frequency band to determine whether the frequency band is idle, the sensing occurring prior to a first time period. In some examples, the apparatus includes means for transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

Certain aspects relate to a non-transitory computer-readable storage medium that stores instructions that when executed by a processor of an apparatus cause the apparatus to perform a method for wireless communication. In some examples, the method includes sensing, by a first user equipment (UE) of a plurality of UEs, a frequency band to determine whether the frequency band is idle, the sensing occurring prior to a first time period. In some examples, the method includes transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

Certain aspects relate to a method of wireless communication. In some examples, the method includes receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs. In some examples, the method includes transmitting, by the first UE, a first signal to another of the plurality of UEs over the frequency band during the first time period.

Certain aspects relate to a first user equipment (UE) of a plurality of UEs. The first UE may include a memory and a processor coupled to the memory. In some examples, the processor and the memory are configured to receive, from a second UE of the plurality of UEs, one or more signals over a frequency band during a first time period, the one or more signals indicating to one or more other wireless devices, configured to communicate using a different wireless technology than the plurality of UEs, that the frequency band is busy during the first time period, the one or more signals further indicating to the first UE that the frequency band is reserved for wireless communication between the plurality of UEs during the first time period. In some examples, the processor and the memory are configured to transmit a first signal over the frequency band to another of the plurality of UEs during the first time period.

Certain aspects relate to an apparatus for wireless communication. In some examples, the apparatus includes means for receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs. In some examples, the apparatus includes means for transmitting, by the first UE, a first signal to another of the plurality of UEs over the frequency band during the first time period.

Certain aspects relate to a non-transitory computer-readable storage medium that stores instructions that when executed by a processor of an apparatus cause the apparatus to perform a method for wireless communication. In some examples, the method includes receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs. In some examples, the method includes transmitting, by the first UE, a first signal to another of the plurality of UEs over the frequency band during the first time period.

Certain aspects relate to a method of wireless communication. In some examples, the method includes performing, by a first user equipment (UE) of a plurality of UEs, a selection process prior to a first time period, the selection process determining whether to select the first UE to transmit one or more signals as a reservation for the first time period. In some examples, the method includes transmitting, by the first UE, the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

Certain aspects relate to an apparatus for wireless communication. In some examples, the apparatus includes a processor and a memory. In some examples, the processor and the memory are configured to perform a selection process prior to a first time period, the selection process determining whether to select the first UE to transmit one or more signals as a reservation for the first time period. In some examples, the processor and the memory are configured to transmit the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

Certain aspects relate to an apparatus for wireless communication. In some examples, the apparatus includes means for performing, by a first user equipment (UE) of a plurality of UEs, a selection process prior to a first time period, the selection process determining whether to select the first UE to transmit one or more signals as a reservation for the first time period. In some examples, the apparatus includes means for transmitting, by the first UE, the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

Certain aspects relate to a non-transitory computer-readable storage medium that stores instructions that when executed by a processor of an apparatus cause the apparatus to perform a method for wireless communication. In some examples, the method includes performing, by a first user equipment (UE) of a plurality of UEs, a selection process prior to a first time period, the selection process determining whether to select the first UE to transmit one or more signals as a reservation for the first time period. In some examples, the method includes transmitting, by the first UE, the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of two example user equipment (UEs), in accordance with certain aspects of the present disclosure.

FIG. 3 is a diagram conceptually illustrating an example of a first UE communicating with one or more other UEs according to aspects of the present disclosure.

FIG. 4 is a diagram illustrating an example frame format, in accordance with certain aspects of the present disclosure.

FIG. 5 is a schematic diagram illustrating an example model of multiple wireless devices operating in an unlicensed spectrum, in accordance with certain aspects of the present disclosure.

FIG. 6 is a signal diagram illustrating an example model of communication, by the wireless devices of FIG. 5, over a frequency band of an unlicensed spectrum, in accordance with certain aspects of the present disclosure.

FIG. 7 is a signal diagram conceptually illustrating a frequency band of an unlicensed spectrum within a time window, in accordance with certain aspects of the present disclosure.

FIG. 8 is a signal diagram conceptually illustrating a frequency band of an unlicensed spectrum within multiple time windows, in accordance with certain aspects of the present disclosure.

FIG. 9 is a signal diagram conceptually illustrating a frequency band of an unlicensed spectrum within multiple time windows, in accordance with certain aspects of the present disclosure.

FIG. 10 is a flow diagram illustrating example operations for wireless communication, in accordance with certain aspects of the present disclosure.

FIG. 11 is a flow diagram illustrating example operations for wireless communication, in accordance with certain aspects of the present disclosure.

FIG. 12 illustrates a communications device that may include various components configured to perform operations for the techniques disclosed herein in accordance with aspects of the present disclosure.

FIG. 13 is a flow diagram illustrating example operations for wireless communication, in accordance with certain aspects of the present disclosure.

FIG. 14 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for facilitating communications between wireless devices, and providing improved techniques for synchronization of wireless communication devices, such as those communicating in one or more unlicensed frequency bands.

Due to scarcity of bandwidth in the licensed spectrum, certain classes or types of devices may not operate exclusively in the licensed spectrum. As such, it is possible that a class of devices (e.g., CV2X devices) may operate in bands of unlicensed spectrum. However, compatibility issues between one class of devices that operate in the unlicensed spectrum (e.g., CV2X devices) and other classes of devices that operate in the unlicensed spectrum (e.g., non-CV2X devices) may prevent, for example, CV2X devices from directly notifying (e.g., by a clear-to-send (CTS) signal) non-CV2X devices of a time window (e.g., a period of time) during which CV2X devices may communicate in and/or reserve the unlicensed spectrum. Thus, in a scenario where, for example, a CTS signal of a CV2X device is not understood as a CTS signal by a non-CV2X device, an option for reserving a time window for CV2X device communication is to continuously transmit, by a CV2X device, signals (e.g., reservation signals and/or data signals) over the frequency band corresponding to the unlicensed spectrum throughout the duration of the time window. The duration of the time window including the entire duration of the time window, meaning for the entire period of time of the time window without periods of time where there is no transmission of such signals. It should be noted that the techniques discussed herein are not limited to CV2X devices, and may be used for other suitable classes/types of devices, such as used for sidelink communications between wireless communication devices.

For example, techniques described herein may relate to communicating over a frequency band of unlicensed spectrum using time-division multiple access (TDMA) techniques to partition use of the frequency band in time into a first time window and a second time window. In one example, the pair of the first time window and the second time window may recur periodically. In some examples, a first group of wireless devices (e.g., one or more CV2X devices separated by grouping from another one or more CV2X devices) may communicate during the first time window, and a second group of wireless devices (e.g., one or more non-CV2X devices) may communicate during the second time window. In one aspect, the use of separate time windows provides the two different groups of devices with fair use of the frequency band.

In some examples, the first group of wireless devices may perform a listen-before-talk (LBT) sensing procedure prior to the first time window to determine whether the frequency band is idle. As used herein, the term “idle” means that energy, as measured on the frequency band by a device (e.g., CV2X device, non-CV2X device, etc.) determining idleness, is below a threshold level. As used herein, the term “busy” means that energy as measured on the frequency band by the device determining idleness is above the threshold level. Such energy may be due to noise or signals within the frequency band.

In one or more aspects, if the frequency band is determined to be idle, the first group of wireless devices may begin transmitting data or reservation signals (any signals specifically for reserving the frequency band and not carrying data) at the start of the first window. The data and reservation signals may indicate to the second group of wireless devices that the frequency band is busy throughout the duration of the first window should the second group of wireless devices attempt to perform an LBT procedure to try to communicate on the frequency band during the first window. Accordingly, the second group of wireless communication devices refrain from communicating during the first window of time. Once the first window of time ends, the second window of time begins, and the first group of wireless devices cease communications. This allows the second group of devices to communicate during the second window of time by performing an LBT procedure. In one example, the first group of wireless devices can impose TDMA-based partitions in time that allow for use of the frequency band between the first group and the second group of wireless devices.

In some examples, the first group of wireless devices may perform a selection process to determine which one or more of the first group of wireless devices will be assigned or selected to transmit the data or reservation signals during the first window. In one example, each of the first group of wireless devices may independently determine whether it should transmit the data or reservation signals during the first time window, meaning which one or more devices are assigned or selected. In another example, the first group of devices may coordinate between each other to determine which one or more devices of the first group of wireless devices should transmit the data or reservation signals during the first time window, meaning which one or more devices are assigned or selected.

It should be noted that though certain aspects are described with respect to CV2X devices and communication in the unlicensed band, it can be appreciated that the aspects may similarly be applicable to other scenarios, other wireless communication devices (e.g., base stations (BSs) and user equipment (UE) as described herein, as well as any other suitable equivalents thereof), and any other types of communications (e.g., sidelink communications) in an unlicensed band, communications (e.g., sidelink communications) in a licensed band, etc.

The techniques discussed herein allow for the synchronization of devices communicating in the unlicensed band without causing interference to other devices operating in the unlicensed band, thereby enhancing device coexistence and enhancing access to the unlicensed band/medium. Such techniques also account for potential unavailability of the unlicensed band due to communication by other devices, such as through the use of LBT and a time window for transmitting synchronization signals as discussed herein. Accordingly, the techniques herein lead to improved reliability of a data communication (e.g., transmission and reception) procedure in an unlicensed spectrum, such that a data transmission is more likely to be transmitted when expected and properly decoded when received. Thus, these techniques can help improve latency, by reducing the time devices have to wait to achieve synchronization. These techniques can further improve data decoding reliability, by allowing devices to be synchronized more quickly and thus be able to decode transmissions. Moreover, the use of a centralized reservation device that controls synchronization among a plurality of devices reduces the complexity of a sideband network of devices by eliminating coordination between each device and a plurality of other devices.

The following description provides examples of techniques for determining which wireless communication devices should serve as reservation devices, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency band, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

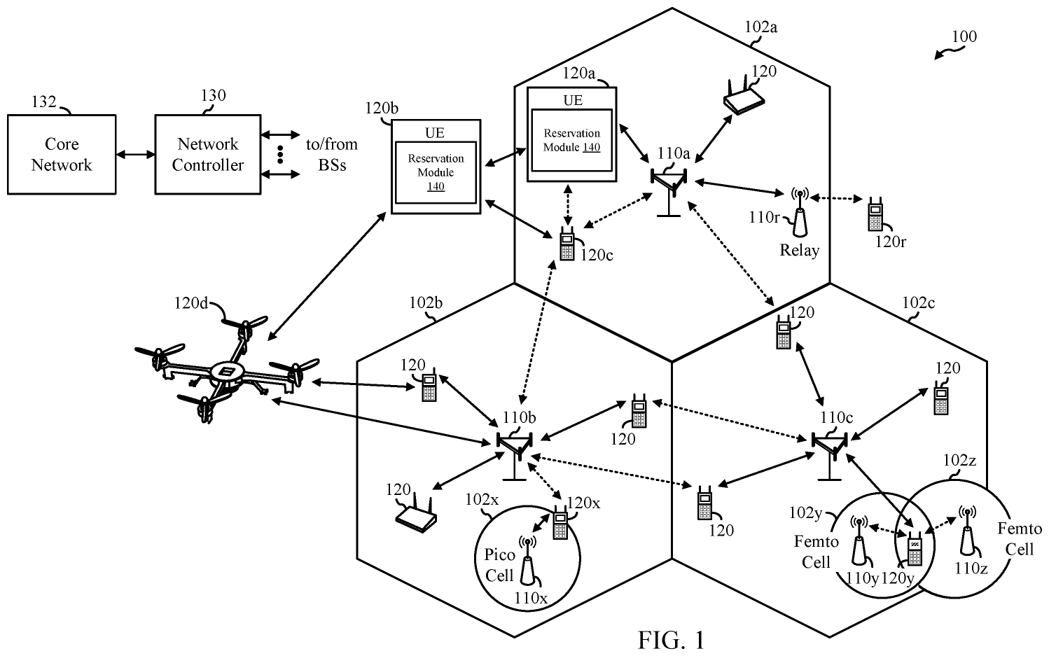

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS 110 may support one or multiple cells. A network controller 130 may couple to a set of BSs 110 and provide coordination and control for these BSs 110 (e.g., via a backhaul).

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. In one example, a quadcopter, drone, or any other unmanned aerial vehicle (UAV) or remotely piloted aerial system (RPAS) 120d may be configured to function as a UE. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

In some examples of the wireless communication network 100, sidelink communication may be established between UEs and/or BSs without necessarily relying on UE ID or control information from a base station. For example, UE 120a may initiate a sidelink communication with UE 120b without relying on a direct connection with a base station (e.g., base station 110a), such as if the UE 120b is outside of cell 102a's range. Any of the UEs illustrated in FIG. 1 may function as a scheduling entity or a primary sidelink device, while the other UEs may function as a subordinate entity or a non-primary (e.g., secondary) sidelink device. Further, the UEs may be configured to transmit synchronization signaling for sidelink as described throughout the disclosure. Accordingly, one or more of the UEs may function as a scheduling entity in a device-to-device (D2D), peer-to-peer (P2P), or vehicle-to-vehicle (V2V) network, and/or in a mesh network to initiate and/or schedule synchronization signaling.

According to certain aspects, UEs 120 may be configured for transmitting reservation signals over a wireless interface, such as in one or more unlicensed frequency bands. As shown in FIG. 1, a first UE 120a and a second UE 120b each include a reservation module 140. The reservation module 140 may be configured to sense (e.g., via listen-before-talk (LBT) process) whether interference exists, or a degree to which interference exists on a frequency band. If the frequency band is determined to be idle, the reservation module 140 may also be configured to perform a selection process prior to a first time period, the selection process determining whether to select the first UE to transmit one or more signals as a reservation for the first time period.

In certain aspects, reservation module 140 may be configured to sense a frequency band to determine whether the frequency band is idle, the sensing occurring prior to a first time period.

In certain aspects, reservation module 140 may be configured to transmit, by the first UE, one or more signals over the frequency band during the first time period based on determining that the frequency band is idle, the one or more signals indicating to one or more other wireless devices, configured to communicate using a different wireless technology than the plurality of UEs, that the frequency band is busy during the first time period, the one or more signals further indicating that the frequency band is reserved for wireless communication between the plurality of UEs during the first time period.

In certain aspects, reservation module 140 may be configured to receive, from a second UE of the plurality of UEs, one or more signals over a frequency band during a first time period, the one or more signals indicating to one or more other wireless devices, configured to communicate using a different wireless technology than the plurality of UEs, that the frequency band is busy during the first time period, the one or more signals further indicating to the first UE that the frequency band is reserved for wireless communication between the plurality of UEs during the first time period.

In certain aspects, reservation module 140 may be configured to transmit a first signal over the frequency band to another of the plurality of UEs during the first time period.

As used herein, the term “idle” is meant to describe the noise or interfering signals on frequency band as being undetectable by a UE 120, or detectable but below a threshold level of power as received by the UE 120 (e.g., a relatively low reference signal receive power (RSRP), received signal strength indicator (RSSI), or any other suitable metric). As used herein, the term “busy” is meant to describe the noise or interfering signals on frequency band as being detectable by a UE 120, or detectable and above a threshold level of power as received by the UE 120 (e.g., a relatively high RSSI).

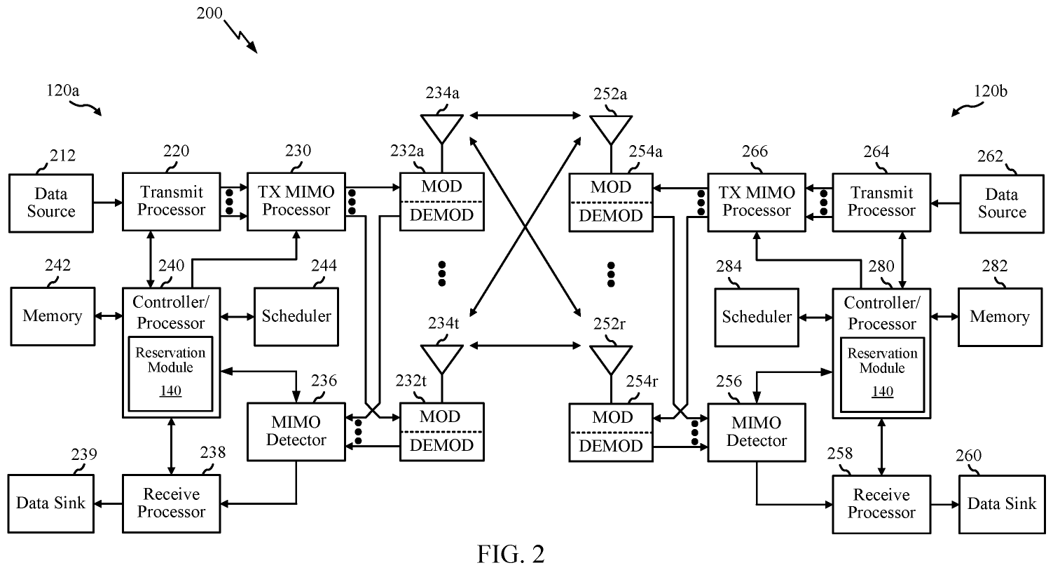

FIG. 2 illustrates example components 200 of a first UE 120a and a second UE 120b (e.g., in the wireless communication network 100 of FIG. 1), which may be used to implement aspects of the present disclosure.

At the first UE 120a, a transmit processor 220 may receive data from a data source 212 and control information from a controller/processor 240. The control information may be for the physical broadcast channel (PBCH), physical sidelink broadcast channel (PSBCH), physical control format indicator channel (PCFICH), physical hybrid automatic repeat request (HARQ) indicator channel (PHICH), physical downlink control channel (PDCCH), group common (GC) PDCCH, etc. The data may be for the physical downlink shared channel (PDSCH), physical sidelink shared channel (PSSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators (MODs) in transceivers 254a-254r (e.g., for SC-FDM, etc.), and transmitted to the BS 110a. At the BS 110a, the uplink signals from the UE 120a may be received by the antennas 234, processed by the modulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for the first UE 120a and second UE 120b, respectively. A scheduler 244/284 may schedule UEs for data transmission/reception.

Antennas 252, processors 266, 258, 264, and/or controller/processor 280 of the second UE 120b and/or antennas 234, processors 220, 230, 238, and/or controller/processor 240 of the first UE 120a may be used to perform the various techniques and methods described herein. For example, as shown in FIG. 2, the controller/processor of both UEs includes a reservation module 140 that may be configured to sense (e.g., via listen-before-talk (LBT) process) whether interference exists, or a degree to which interference exists on a frequency band. The reservation module 140 may be configured to sense (e.g., via listen-before-talk (LBT) process) whether interference exists, or a degree to which interference exists on a frequency band. If the frequency band is determined to be idle, the reservation module 140 may also be configured to perform a selection process prior to a first time period, the selection process determining whether to select the first UE to transmit one or more signals as a reservation for the first time period.

In certain aspects, reservation module 140 may be configured to sense a frequency band to determine whether the frequency band is idle, the sensing occurring prior to a first time period.

In certain aspects, reservation module 140 may be configured to transmit, by the first UE, one or more signals over the frequency band during the first time period based on determining that the frequency band is idle, the one or more signals indicating to one or more other wireless devices, configured to communicate using a different wireless technology than the plurality of UEs, that the frequency band is busy during the first time period, the one or more signals further indicating that the frequency band is reserved for wireless communication between the plurality of UEs during the first time period.

In certain aspects, reservation module 140 may be configured to receive, from a second UE of the plurality of UEs, one or more signals over a frequency band during a first time period, the one or more signals indicating to one or more other wireless devices, configured to communicate using a different wireless technology than the plurality of UEs, that the frequency band is busy during the first time period, the one or more signals further indicating to the first UE that the frequency band is reserved for wireless communication between the plurality of UEs during the first time period.

In certain aspects, reservation module 140 may be configured to transmit a first signal over the frequency band to another of the plurality of UEs during the first time period.

NR may utilize orthogonal frequency division multiplexing (OFDM) with a cyclic prefix (CP). NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

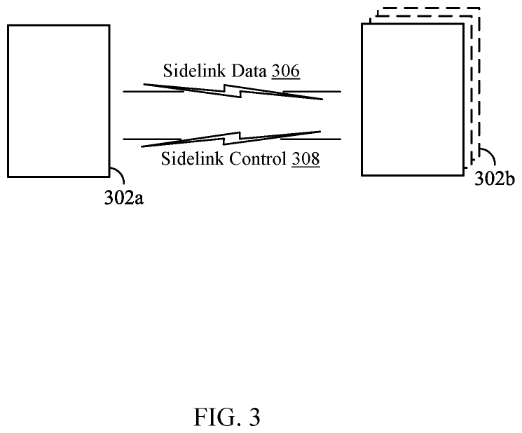

FIG. 3 is a diagram conceptually illustrating a sidelink communication between a first UE 302a and one or more second UEs 302b (collectively, “UEs 302”). In various examples, any one of the first UE 302a and the second UE 302b may correspond to a UE (e.g., UE 120a or UE 120b of FIGS. 1 and 2) or other suitable node in the wireless communication network 100.

In some examples, the first UE 302a and the second UE 302b may utilize sidelink signals for direct D2D communication. The D2D communication may use the downlink/uplink wireless wide area network (WWAN) spectrum and/or an unlicensed spectrum. The D2D communication may use one or more sidelink channels, such as a physical sidelink broadcast channel (PSBCH), a physical sidelink discovery channel (PSDCH), a physical sidelink shared channel (PSSCH), and a physical sidelink control channel (PSCCH) over these spectrums. D2D communication may be through a variety of wireless D2D communications systems, such as for example, FlashLinQ, WiMedia, Bluetooth, ZigBee, WiFi based on the institute of electrical and electronic engineers (IEEE) 802.11 standard, LTE, or NR.

Sidelink signals may include sidelink data 306 (i.e., sidelink traffic) and sidelink control information 308. Broadly, the first UE 302a and one or more second UEs 302b may communicate sidelink data 306 and sidelink control information 308 using one or more data channels and control channels. In some aspects, data channels include the PSSCH, and control channels include the PSCCH and/or physical sidelink feedback channel (PSFCH).

Sidelink control information 308 may include a source transmit signal (STS), a direction selection signal (DSS), and a destination receive signal (DRS). The DSS/STS may provide for a UE 302 (e.g., 302a, 302b) to request a duration of time to keep a sidelink channel available for a sidelink signal; and the DRS may provide for the UE 302 to indicate the availability of the sidelink channel, e.g., for a requested duration of time. Accordingly, the first UE 302a and the second UE 302b may negotiate the availability and use of sidelink channel resources prior to communication of sidelink data 306 information.

In some configurations, any one or more of the first UE 302a or the second UE 302b may periodically/aperiodically transmit or broadcast sidelink synchronization signaling to increase chances of detection by another UE or BS. For example, one or more of the first UE 302a and the second UE 302b may periodically/aperiodically transmit sidelink synchronization signals in one or more slots of specific time windows. In some examples, the UEs are (e.g., pre-) configured with information indicating the location and duration of the time window within a frame (e.g., which slots within the frame, and how many). In some aspects, the UEs may be configured with the location and duration of the time window via messaging between UEs or messaging received from a BS (e.g., radio resource control (RRC) signaling).

The channels or carriers illustrated in FIG. 3 are not necessarily all of the channels or carriers that may be utilized between a first UE 302a and a second UE 302b in a sidelink communication, and those of ordinary skill in the art will recognize that other channels or carriers may be utilized in addition to those illustrated, such as other data, control, and feedback channels.

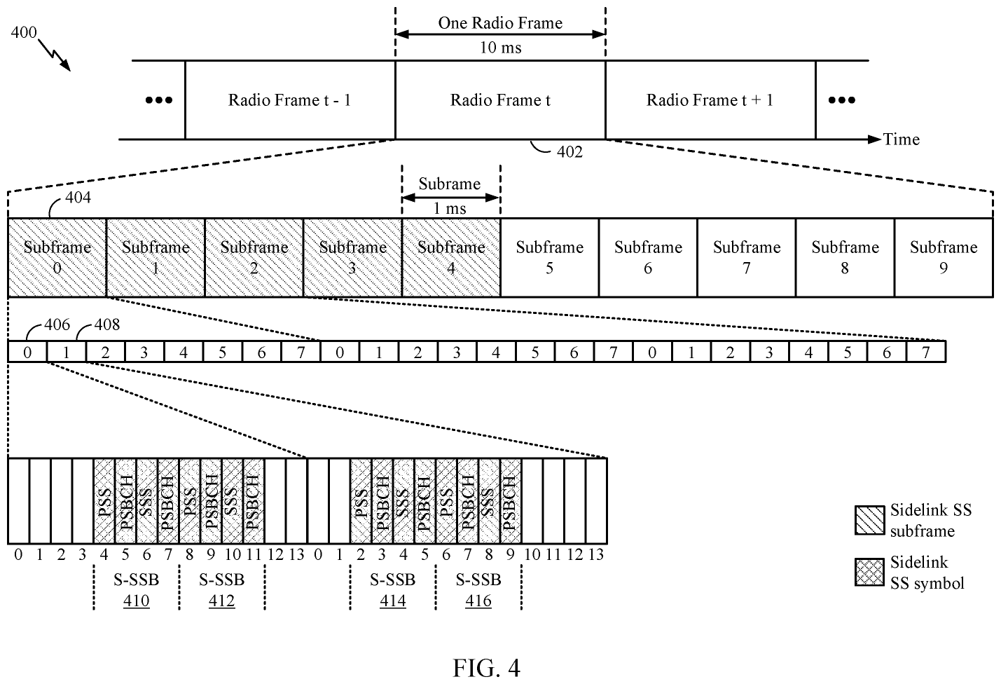

FIG. 4 is a diagram showing an example of a frame format 400. The transmission timeline for each data transmission and reception may be partitioned into units of radio frames 402. In NR, the basic transmission time interval (TTI) may be referred to as a slot. In NR, a subframe may contain a variable number of slots (e.g., 1, 2, 4, 8, 16, . . . , N slots) depending on the subcarrier spacing (SCS). NR may support a base SCS of 15 KHz and other SCS may be defined with respect to the base SCS (e.g., 30 kHz, 60 kHz, 120 kHz, 240 kHz, etc.). In the example shown in FIG. 4, the SCS is 120 kHz. As shown in FIG. 4, the subframe 404 (subframe 0) contains 8 slots (slots 0, 1, . . . , 7) with a 0.125 ms duration. The symbol and slot lengths scale with the subcarrier spacing. Each slot may include a variable number of symbol (e.g., OFDM symbols) periods (e.g., 7 or 14 symbols) depending on the SCS. For the 120 kHz SCS shown in FIG. 4, each of the slot 406 (slot 0) and slot 408 (slot 1) includes 14 symbol periods (slots with indices 0, 1, . . . , 13) with a 0.25 ms duration.

In sidelink, a sidelink synchronization signal block (S-SSB), referred to as the SS block or SSB, is transmitted. The SSB may include a primary SS (PSS), a secondary SS (SSS), and/or a two symbol physical sidelink broadcast channel (PSBCH). In some examples, the SSB can be transmitted up to sixty-four times with up to sixty-four different beam directions. The up to sixty-four transmissions of the SSB are referred to as the SS burst set. SSBs in an SS burst set may be transmitted in the same frequency region, while SSBs in different SS bursts sets can be transmitted in different frequency regions.

In the example shown in FIG. 4, in the subframe 404, SSB is transmitted in each of the slots (slots 0, 1, . . . , 7). In the example shown in FIG. 4, in the slot 406 (slot 0), an SSB 410 is transmitted in the symbols 4, 5, 6, 7 and an SSB 412 is transmitted in the symbols 8, 9, 10, 11, and in the slot 408 (slot 1), an SSB 414 is transmitted in the symbols 2, 3, 4, 5 and an SSB 416 is transmitted in the symbols 6, 7, 8, 9, and so on. The SSB may include a primary SS (PSS), a secondary (SSS), and a two symbol physical sidelink broadcast channel (PSBCH). The PSS and SSS may be used by UEs to establish sidelink communication (e.g., transmission and/or reception of data and/or control channels). The PSS may provide half-frame timing, the SS may provide cyclic prefix (CP) length and frame timing. The PSBCH carries some basic system information, such as system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), and other system information (OSI) can be transmitted on a physical sidelink shared channel (PSSCH) in certain subframes.

Cellular vehicle to everything (CV2X) communications in a licensed spectrum are generally synchronous in the sense that transmissions are generally aligned in terms of the time and frequency resources illustrated in FIG. 4. For example, in certain aspects, the allocation of frames, subframes, slots, etc. are provisioned for by network protocols and rules that apply to wireless communications in the licensed spectrum. For example, establishing time synchronization when operating in a licensed spectrum, may include: (i) using global navigation satellite system (GNSS) as a common time reference (e.g., current coordinated universal time (UTC)), from which a UE derives frame and slot boundaries; and/or (ii) using an in-band signaling method, with synchronization signals (e.g., beacon signals) broadcasted by devices.

However, as discussed, it is possible that CV2X communications may operate in one or more frequency bands of the unlicensed spectrum. Thus, in some examples, GNSS-based synchronization between CV2X devices (e.g., UEs and/or BSs) may be applied in the unlicensed spectrum. In certain aspects, GNSS-based synchronization between CV2X devices may be achieved without signaling overhead (e.g., without synchronization signaling). However, if GNSS-based synchronization is not available or is undesirable due to, for example, reliability issues, it may be preferable that synchronization between CV2X devices is established via periodic, in-band broadcast signaling of synchronization signals.

Thus, a procedure for deploying CV2X operations in an unlicensed spectrum is desirable.

### Example Techniques for Time-Division Multiple Access (TDMA) Based Communications in Unlicensed Bands

Aspects of the present disclosure provide for implementing TDMA-based techniques and frame formats to support CV2X communications in an unlicensed spectrum. In one example, one or more CV2X devices utilize periodic intervals for communication (e.g., the TDMA aspect), where time is partitioned into “CV2X windows” and “non-CV2X windows” that may recur periodically. In this example, the one or more CV2X devices may communicate during periodic CV2X windows in an unlicensed spectrum, while refraining from communication during non-CV2X windows to allow one or more other wireless devices an opportunity to transmit and receive data. In certain aspects, within the CV2X windows, the one or more CV2X devices may communicate using aspects of the same frame format used in a licensed spectrum. That is, one or more CV2X devices may partition the CV2X window into slots as illustrated in FIG. 4.

In certain aspects, the duration of the CV2X and non-CV2X windows may depend on where the communication system is deployed. For example, if a particular area has a relatively high amount of non-CV2X wireless communication traffic over the unlicensed spectrum, the CV2X windows may be reduced in time duration, and the non-CV2X windows may be increased in time duration. In another example, if a particular area has a relatively high number of CV2X devices, and/or a relatively high amount of wireless communication between the CV2X devices, CV2X windows may be increased in time duration, and the non-CV2X windows may be decreased in time duration.

In certain aspects, one or more non-CV2X devices are not designed for such a TDMA operation. Thus, the one or more CV2X devices may impose TDMA time partitioning (e.g., CV2X windows and non-CV2X windows) on the one or more non-CV2X devices. In certain aspects, such as to abide by regulatory requirements for unlicensed spectrum use, the imposition of TDMA operations by the one or more CV2X devices may include a listen-before-talk (LBT) procedure.

In some examples, multiple CV2X devices may perform the LBT procedure prior to a scheduled CV2X window to determine whether a frequency band in the unlicensed spectrum is idle prior to communicating over the frequency band. If the CV2X device senses the frequency band as idle, the device may transmit a clear-to-send (CTS) signal indicating a channel occupancy time (COT) corresponding to the duration of the CV2X window, or a remaining duration of the CV2X window. The COT may indicate for how long the frequency band is to be “occupied” or used by the CV2X devices. The CTS signal may be transmitted in a format compatible with the non-CV2X devices. If multiple CV2X devices transmit the CTS signal, in certain aspects, that may increase the number of non-CV2X devices that receive CTS as the signals may reach a larger geographic area, thereby reducing the number of non-CV2X devices that fail to receive a CTS signal and may therefore try to communicate during the CV2X window.

In some examples, the CTS signal may span a short duration and be configured to inform one or more non-CV2X devices that the frequency band will be occupied by one or more CV2X devices during the CV2X window, and not to access the frequency band within the CV2X window. Thus, in some examples, the one or more non-CV2X devices are provided with an indication of a duration of the CV2X window, or remaining duration of the CV2X window, during which the one or more non-CV2X devices can refrain from transmitting data. In certain aspects, the one or more non-CV2X devices may refrain from communicating over the frequency band during the CV2X window even if the frequency band is idle for the entire duration or a portion of the duration of the CV2X window. To be clear, non-CV2X devices may refrain from communication over the frequency band for the whole duration of the CV2X window (e.g., the entire CV2X window), or a portion of the CV2X window (e.g., less than the entire/whole CV2X window). This allows for CV2X device operation and communication without interference from any non-CV2X devices that received the CTS signal.

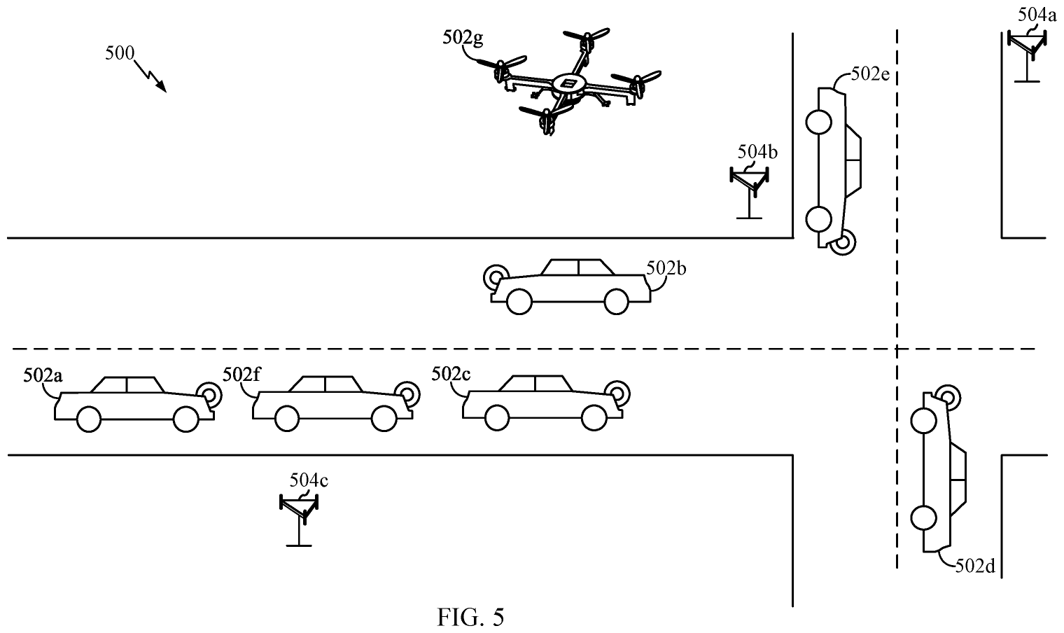

FIG. 5 is a schematic diagram illustrating an example network 500 of multiple CV2X devices operating in an unlicensed spectrum. In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g)—collectively referred to as CV2X devices 502) may operate in an unlicensed spectrum with other non-CV2X devices (e.g., non-CV2X devices 504a-c—collectively referred to as non-CV2X devices 504). In some examples, the first CV2X device 502a, the sixth CV2X device 502f, and the third CV2X device 502c may be part of a fleet. Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include UEs (e.g., UE 120 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter.

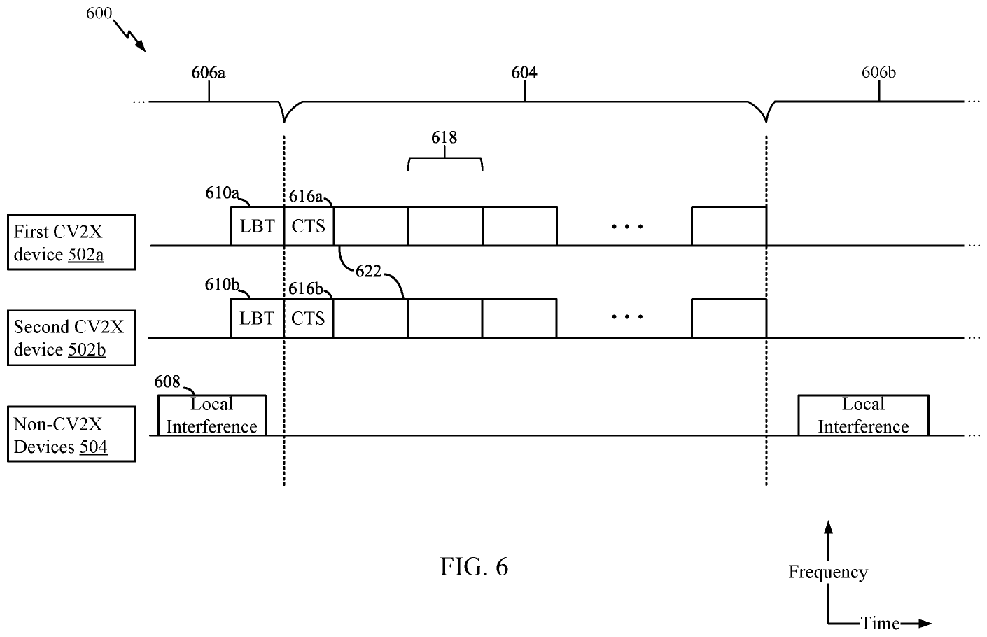

FIG. 6 is a signal diagram illustrating an example model 600 of communication, by two example CV2X devices 502 (e.g., the first CV2X device 502a and the second CV2X device 502b) of FIG. 5, over a frequency band of an unlicensed spectrum. In this diagram, a time dimension is indicated on an x-axis, and a frequency dimension is indicated on a y-axis of the model 600. However, it should be noted that the frequency resources used by each of the first CV2X device 502a, the second CV2X device 502b, and the non-CV2X devices 504 may be the same, different, or partially overlapping with one or more of the other of the first CV2X device 502a, the second CV2X device 502b, or the non-CV2X devices 504. In this example, the first CV2X device 502a performs an LBT procedure 610a, and the second CV2X device 502b performs another LBT procedure 610b. Both LBT procedures 610 are performed during a non-CV2X window 606a, prior to the start of a CV2X window 604. In certain aspects, the LBT procedures 610 are performed and then the CV2X window 604 begins without a gap between the LBT procedures 610 and the CV2X window 604. Although any suitable duration is contemplated by this disclosure, in one example, each of the LBT procedures 610 may last 25μ seconds. In the illustrated example, none of the non-CV2X devices 504 are transmitting data during the LBT procedures 610. As such, neither of the CV2X devices 502 will detect energy from signals from the non-CV2X device 504 on the frequency band, and may determine that the frequency band is idle.

In this example, upon determination that the frequency band is idle, the first CV2X device 502a may transmit a CTS signal 616a and the second CV2X device 502b may transmit a CTS signal 616b at the beginning of the CV2X window 604. In this example, the CTS signals 616 indicate to the non-CV2X devices 504 a COT that is equal to the remaining duration of the CV2X window (e.g., the duration of the CV2X window 604 remaining after the CTS signals 616). Communication of data (e.g., receive or transmit) by the CV2X devices 502 may initiate, upon receipt of the CTS signals 616, the communication using CV2X slots 618. For example, during a first slot 622, the first CV2X device 502a may be in a transmit mode, and may transmit data to the second CV2X device 502b. Accordingly, during the first slot 622, the second CV2X device 502b may be in a receive mode to receive the data transmitted by the first device 502a. At the end of the CV2X window 604, the CV2X devices 502 may cease communication and another non-CV2X window 606b may begin.

### Example Techniques for Reservation Signal Transmission

As discussed, transmission of CTS signals by CV2X devices to non-CV2X device may not always be possible. Thus, in certain aspects, the CV2X window is reserved for CV2X device communication by continuously transmitting signals (e.g., reservation signals and/or data signals) over the frequency band throughout the CV2X window duration. That is, the CV2X device(s) signals are continuously transmitted throughout the CV2X window duration so that there are no “energy gaps” within the CV2X window that a non-CV2X device could interpret as an opportunity to initiate communication during the CV2X window. Instead, with continuous transmission, non-CV2X devices will sense energy on the frequency band and will refrain from using the frequency band for transmission during the CV2X window.

Thus, in certain aspects, when a CV2X device has no data to transmit during a particular time period within the CV2X window (e.g., such time period referred to as a CV2X slot), it may transmit a reservation signal. For example, the CV2X window may be divided into a number of slots, similar to slot 406 of FIG. 4. In certain aspects, a CV2X window may correspond in time to a subframe, such as subframe 404 of FIG. 4. The reservation signal can be any arbitrary signal or noise. In some examples, CV2X devices may be half-duplex devices, which are devices that can only one of transmit or receive at a time, and cannot both transmit and receive at the same time. Thus, in certain aspects, data transmitted by a CV2X device during a time period may not be received by another CV2X device during that time period if the other CV2X device is transmitting a reservation signal during that time period. In some examples, CV2X devices may be full-duplex devices that can transmit and receive at the same time.

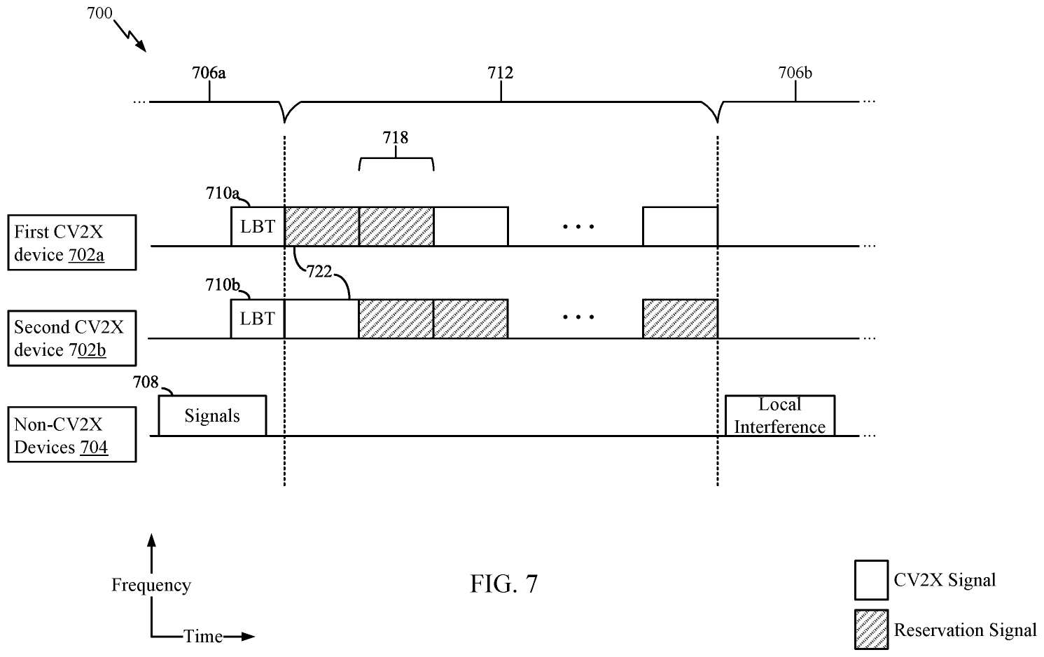

FIG. 7 is a signal diagram illustrating an example model 700 of communication by CV2X devices 702 (e.g., UE 120 of FIGS. 1 and 2, UE 302 of FIG. 3, and CV2X devices 502 of FIG. 5) over a frequency band of an unlicensed spectrum. In this diagram, a time dimension is indicated on an x-axis, and a frequency dimension is indicated on a y-axis of the model 700. However, it should be noted that the frequency resources used by each of a first CV2X device 702a, a second CV2X device 702b, and non-CV2X devices 704 may be the same, different, or partially overlapping with one or more of the other of the first CV2X device 702a, the second CV2X device 702b, or the non-CV2X devices 704.

Here, the first CV2X device 702a performs an LBT procedure 710a, and the second CV2X device 702b performs another LBT procedure 710b. Both LBT procedures 710 are performed during a non-CV2X window 706a prior to the start of a CV2X window 712. Because no signals 708 generated by non-CV2X devices 704 are detected by the LBT procedure 710 prior to the start of the CV2X window 712, the CV2X devices 702 may determine that the frequency band is idle, and begin transmission of data and/or reservation signals throughout the duration of the CV2X window 706.

In this case, the CV2X devices 702 do not transmit a CTS signal prior to or during the CV2X window 712. Thus, the start of a first CV2X slot 722 within the CV2X window 712 coincides with the start of the CV2X window 712. Here, without the CTS signaling, the CV2X devices 702 transmit a reservation signal over: (i) slots that the devices do not have data to transmit, and (ii) over the last symbol of a CV2X slot that is used to transmit data. That is, the reservation signal may be substituted for CTS signaling, thereby freeing up additional time resources for communications between the CV2X devices 702 that would have otherwise been occupied with CTS signaling.

### Example Techniques for CV2X Window Reservation

In certain aspects, one or more CV2X devices, such as all in a deployment, may be configured to serve as a “reservation device,” meaning that if any such CV2X device is not transmitting CV2X data, that device is transmitting a reservation signal. However, in other aspects, only one or a subset of CV2X devices may serve as reservation devices. That is, one device, or more than one device but less than all devices in a deployment may serve as a reservation device. In certain aspects, reservation devices are the only CV2X devices that transmit reservation signals. In certain aspects, a reservation device only transmits a reservation signal if it does not have data to transmit. As such, a reservation device may always be transmitting either reservation signals or data within a CV2X window. In certain aspects, remaining CV2X device(s) (e.g., CV2X devices that are not reservation devices) do not transmit reservation signals and treat the CV2X window as available for transmission and reception, such as similar to a coordinated, CTS-based reservation.

In certain aspects, the one or more CV2X devices that serve as reservation devices may change according to CV2X window changes or over one or more time intervals. For example, in certain aspects, which CV2X device(s) serve as reservation device(s) may change at the start of every CV2X window or at some other time interval within the CV2X window (e.g., after one or more CV2X slots within the CV2X window). Changing which device(s) serve as reservation device(s) may allow different CV2X devices an opportunity to receive data at some point in time.

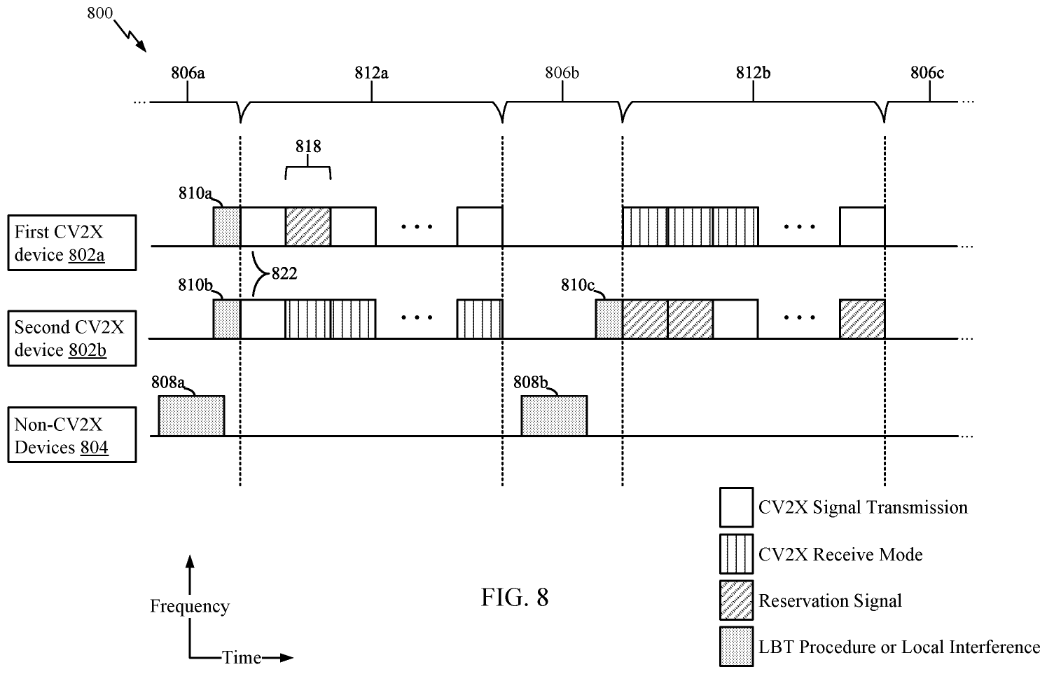

FIG. 8 is a signal diagram illustrating an example model 800 of communication by CV2X devices 802 (e.g., UE 120 of FIGS. 1 and 2, UE 302 of FIG. 3, and CV2X devices 502 of FIG. 5) over a frequency band of an unlicensed spectrum. In this diagram, a time dimension is indicated on an x-axis, and a frequency dimension is indicated on a y-axis of the model 800. However, it should be noted that the frequency resources used by each of a first CV2X device 802a, a second CV2X device 802b, and non-CV2X devices 804 may be the same, different, or partially overlapping with one or more of the other of the first CV2X device 802a, the second CV2X device 802b, or the non-CV2X devices 804.

Here, the first CV2X device 802a performs an LBT procedure 810a and the second CV2X device 802b performs an LBT procedure 810b during a first non-CV2X window 806a and prior to the start of a first CV2X window 812a. Because no signal is detected as transmitted by non-CV2X devices 804 prior to the start of the first CV2X window 812a, the CV2X devices 802 may determine that the frequency band is idle, and begin transmission of data and/or reservation signals throughout the duration of the first CV2X window 812a over CV2X slots 818.

As discussed, one or more of the CV2X devices 802 may serve as reservation devices during a CV2X window. In this example, the first CV2X device 802a serves as a reservation device during the first CV2X window 812a, while the second CV2X device 802b operates as normal (e.g., does not transmit a reservation signal if it has no data to transmit). Note that both CV2X devices 802 may implement an LBT procedure 810 prior to the start of the first CV2X window 812a. In some examples, as with the case of the first CV2X device 802a for the first CV2X window 812a, any CV2X device that serves as a reservation device may perform the LBT procedure prior to the start of a CV2X window for which they serve as a reservation device. In some examples, as with the case of the second CV2X device 802b, any device that is not a reservation device but will transmit data in the first CV2X slot 822 of a CV2X window may also perform an LBT process to confirm that the frequency band is idle before it begins transmission.

Once the first CV2X window 812a ends, the CV2X devices 802 end CV2X communications and a second non-CV2X window 806b begins, wherein non-CV2X devices 804 may communicate over the frequency band, such as without interference from the CV2X devices 802. At a later point in time, a second CV2X window 812b begins. As discussed, the one or more CV2X devices that serve as reservation devices may change over one or more time intervals. In certain aspects, which CV2X device 802 will serve as a reservation device may change before every new CV2X window. In certain aspects, the second CV2X device 802b may serve as the reservation device during the second CV2X window 812b. Note that in this case, only the second CV2X device 802b is performing the LBT process prior to the start of the second CV2X window 812b. This is because the first CV2X device 802a is no longer serving as a reservation device, and because the first CV2X device 802a is not transmitting during the first slot of the second CV2X window 812b.

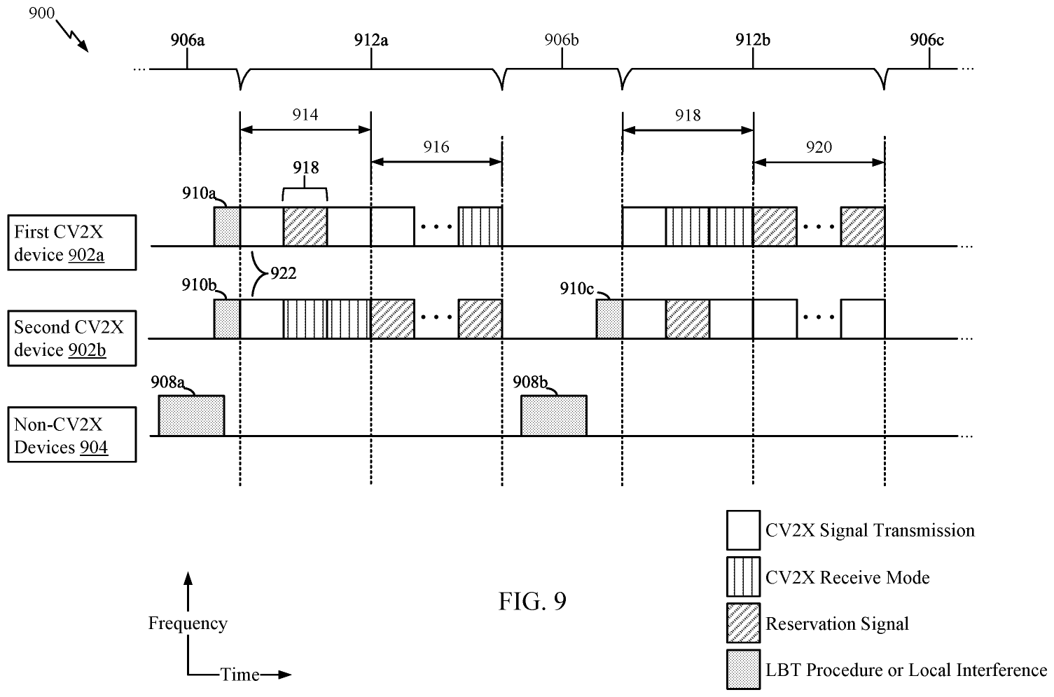

FIG. 9 is a signal diagram illustrating an example model 900 of communication by the CV2X devices 902 (e.g., UE 120 of FIGS. 1 and 2, UE 302 of FIG. 3, and CV2X devices 502 of FIG. 5) over a frequency band of an unlicensed spectrum. In this diagram, a time dimension is indicated on an x-axis, and a frequency dimension is indicated on a y-axis of the model 900. However, it should be noted that the frequency resources used by each of a first CV2X device 902a, a second CV2X device 902b, and non-CV2X devices 904 may be the same, different, or partially overlapping with one or more of the other of the first CV2X device 902a, the second CV2X device 902b, or the non-CV2X devices 904.

Here, the same processes are performed as described in FIG. 8 above. However, as discussed, one or more CV2X devices that serve as reservation devices may change. In certain aspects, the CV2X devices 902 serving as reservation devices may change halfway, or at one or more time intervals, during each CV2X window.

In this example, a first non-CV2X window 906a may initially include some signals 908a produced by non-CV2X devices 904. However, each of the first CV2X device 902a and the second CV2X device 902b perform an LBT procedure wherein prior to a first CV2X window 912a, the frequency band is determined to be idle. During the first CV2X window 912a, in certain aspects, the first CV2X device 902a functions as a reservation device for a first interval 914 of the first CV2X window 912a, but does not function as a reservation device for a second interval 916. Rather, the second CV2X device 902b may function as the reservation device for the second interval 916.

Similarly, after a second non-CV2X window 906b, the second CV2X device 902b may perform the LBT procedure 910c and not detect any signals 908b. Here, the second CV2X device 902b functions as a reservation device for a first interval 918 of the second CV2X window 912b, and the first CV2X device 902a functions as a reservation device for a second interval 920 of the second CV2X window 912b.

### Example Techniques for Selecting a Reservation Device

As discussed, one or more CV2X devices may serve as a reservation device for a period of time and not for another period of time. Rather, one or more other CV2X devices may serve as a reservation device for the other period of time.

According to one or more aspects, one or more CV2X devices may be configured to perform a selection process, such as prior to one or more periods of time (e.g., an entire CV2X window, a portion of a CV2X window, etc.). The selection process may be configured to determine, at each of the one more CV2X devices, whether that CV2X device is going to serve as a reservation device such as for a particular (e.g., next preconfigured) period of time. That is, whether the CV2X device is going to transmit one or more signals as a reservation signal during the period of time. Each of the one or more CV2X devices that are selected by the selection process to serve as a reservation device for the period of time may transmit one or more signals over a frequency band for the entire period of time (e.g., for the whole duration of that period of time without a gap). In this example, the one or more signals indicate to any non-CV2X devices that the frequency band is unavailable during the period of time, as should the non-CV2X devices perform LBT, they will sense the frequency band as busy. Accordingly, the frequency band is configured for wireless communication by CV2X devices during the period of time. It should be noted that the one or more signals transmitted by a reservation device may include one or more of a data transmission or a reservation signal.

In some examples, the selection process may include each of the one or more CV2X devices randomly generating a number within a range of numbers (e.g., [0,1]). Each of the CV2X devices may then determine whether the randomly generated number satisfies a threshold value (e.g., pₜₕ∈(0,1)). Then, for each of the one or more CV2X devices whose randomly generated number satisfies the threshold value (e.g., is less than, is greater than, etc.), that CV2X device is selected to operate as a reservation device for at least a period of time.

In some examples, the selection process may include each CV2X device independently generating a random number uniformly distributed over [0, 1]. If the randomly generated number is less than a (e.g., preconfigured) threshold pₜₕ∈(0,1), that CV2X device will serve as the reservation device for a (e.g., next) period of time (e.g., at least a portion of a CV2X window). Note that each CV2X device may be (e.g., pre-) configured with the threshold value which may be the same for all CV2X devices. Moreover, each of the CV2X devices may also be (e.g., pre-) configured with: (i) the times at which the CV2X device performs the selection process to determine whether to serve as a reservation device, and (ii) the duration of time for which each CV2X device will serve as a reservation device.

As discussed, in certain aspects, the one or more CV2X devices may be configured to perform a selection process prior to a period of time (e.g., a CV2X window or a portion thereof). As such, each CV2X device will know whether it will serve as a reservation device prior to the period of time, providing the CV2X device with the ability to schedule data transmissions during periods when the device will serve as a reservation device.

Thus, certain first aspects offer a relatively simple method for selecting a reservation device that requires no coordination between CV2X devices.

According to one or more aspects, the threshold value of each of the CV2X devices may be configured such that the probability of becoming a reservation UE depends on one or more of: (i) a number of times the CV2X device has served as a reservation device in the past (e.g., the frequency that the CV2X device served as a reservation device, over a past time duration, etc.), (ii) a number of transmissions the CV2X device already has scheduled for the time period that the CV2X device may serve as a reservation device, (iii) energy (which may cause local interference local to the CV2X device) sensed by the CV2X device, and/or (iv) one or more other parameters. For example, a CV2X device that has served as a reservation device relatively few times in the past may have higher probability of becoming a reservation device (e.g., higher threshold value). In another example, a CV2X device that has a relatively high number of scheduled transmissions within the time period of interest may have a higher probability of becoming a reservation device. In this case, if the CV2X device has a relatively high number of scheduled transmissions, that device can transmit reservation signals during any remaining time (e.g., in the remaining slots) of a period of time. In some examples, the cost of being a “transmit-only” reservation device is minimized. In some examples, a CV2X device that measures or senses a relatively high level of energy in the frequency band may have a higher probability of becoming a reservation device. For example, a number of non-CV2X devices that may receive the reservation signal from such a CV2X device experiencing high local interference and thus refrain from communicating during the time period, may potentially be greater as the high interference may be indicative of a larger number of non-CV2X devices in the vicinity of the CV2X device.

Thus, in some examples, each of the one or more CV2X devices may be configured to calculate the threshold value based on one or more operational parameters, such as one or more of the number of times the CV2X device has previously been selected by the selection process for one or more previous time periods, the number of data transmissions already scheduled for the CV2X device to transmit during the next time period, and/or an energy level measured or sensed by the CV2X device in the frequency band. In certain aspects, the threshold value is updated locally by each CV2X device based on a (e.g., configured) formula with inputs described above.

According to one or more aspects, the threshold value of each of the one or more CV2X devices may depend on more than just operational parameters local to the CV2X device. That is, each of the CV2X devices may receive and adjust the threshold value according to, at least in part, operational parameters of other CV2X devices.

For example, in addition to local operational parameters used by the CV2X devices to determine the threshold, a CV2X device may use information from other CV2X devices as well. In certain aspects, one or more (e.g., each) of the one or more CV2X devices may broadcast parameters such as number of times they have been reservation devices. This information may be transmitted as part of sidelink control information (SCI) over sidelink control channel, or part of payload or some other signaling (e.g., control signaling over a licensed band), such as dedicated for that purpose. In certain aspects, each of the CV2X devices may compile this information with its own local operational parameters to determine its threshold value based on a (e.g., pre-configured, configured, etc.) formula or algorithm.

In certain aspects, if another CV2X device indicates that it has served as a reservation device more often than a first CV2X device, the first CV2X device may adjust the threshold (e.g., increase the threshold) to increase its probability of becoming a reservation device. Thus, calculating the threshold value may be based on one or more operational parameters of the first CV2X device, as well as one or more operational parameters of one or more other CV2X devices.

According to one or more aspects, a plurality of CV2X devices may be partitioned into a number of N groups, where N>2. In this aspect, each of the groups may be indexed as 0, 1, . . . , N−1. In some examples, the number of groups may depend on the number of CV2X devices. For instance, each of the CV2X devices may be (e.g., pre-) configured with a mapping between a number of CV2X devices and a number of groups. In some examples, the number of groups may be an arbitrary value (e.g., a value selected at random). Alternatively, the number of groups may be preconfigured at each CV2X device, or configured at each device via signaling by a licensed band network (e.g., BS 110 or core network (CN) 132 of FIG. 1) or by signaling in an unlicensed band network.

In certain aspects, the partitioning can be made randomly (e.g. based on a random number generated by each of the CV2X devices) and independently by each CV2X device. In certain aspects, the partitioning may be made in a coordinated manner among the CV2X devices based on information exchanged between each of the devices (e.g., exchanging the operational parameters described above of each of the CV2X devices over a licensed CV2X band). Alternatively, each CV2X device may be assigned to a group via signaling by a licensed band network (e.g., BS 110 or CN 132 of FIG. 1) or by signaling in an unlicensed band network. That is, each CV2X device may receive a group assignment from the network.

In certain aspects, where each of the CV2X devices are configured to operate as a reservation device for the duration of a period of time (e.g., a single CV2X window, or a portion thereof), each of the CV2X devices may determine whether they are to serve as a reservation device for a particular window using a mathematical formula. In certain aspects, the mathematical formula may include the following modulo function:

mod(n,N)

Here, the formula may return a numeric value corresponding to n modulo N, wherein n may correspond to an index or identifier of a particular period of time, and where N corresponds to the group that a particular CV2X device belongs to. Thus, the devices that become reservation UEs for the n^{th} period of time are those belonging to the group mod (n, N). It should be noted that different reservation durations are contemplated. For example, n may correspond to an index or identifier of a particular portion of a CV2X window where reservation durations are less than the entire CV2X window.

In another example, each of the CV2X devices may determine whether they are part of a group that will serve as a reservation device based on whether a calculated value satisfies a threshold. For example, the device(s) of one group may aggregate the operational parameters of each device in the group, and calculate a numeric value using an algorithm or equation. If the numeric value satisfies the threshold, then that group may serve as reservation devices for a particular period of time.

Thus, in some examples, a CV2X device of a plurality of CV2X devices may determine that the device belongs to a first group of a plurality of groups, wherein each of the plurality of groups comprise one or more of the plurality of CV2X devices. The selection process may be configured to select the CV2X device for the first time period based on the first group corresponding to a particular period of time.

In some examples, determining that the CV2X device belongs to the first group includes randomly selecting, by the CV2X device, the first group from the plurality of groups. In some examples, determining that the CV2X device belongs to the first group includes receiving, by the CV2X device from another CV2X device of the plurality of CV2X devices, an indication that the CV2X device belongs to the first group. In some examples, determining that the CV2X device belongs to the first group includes selecting, by the CV2X device, the first group based on one or more operational parameters of the CV2X device.

In some examples, the CV2X device may determine that another CV2X device of the plurality of CV2X devices belongs to a first group of a plurality of groups, wherein each of the plurality of groups include one or more of the plurality of CV2X devices. Here, the determining may be based on operational parameters of the second UE. The CV2X device may then transmit an indication that the other CV2X device belongs to the first group, to the other CV2X device.

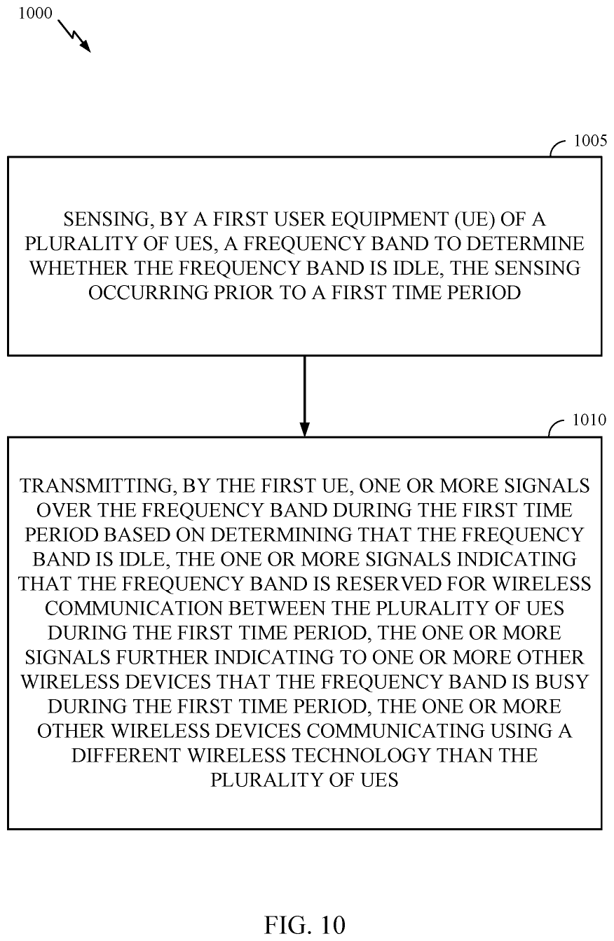

FIG. 10 is a flow diagram illustrating example operations 1000 for wireless communication, in accordance with certain aspects of the present disclosure. The operations 1000 may be performed, for example, by a UE (e.g., such as the UE 120a or UE 120b in the wireless communication network 100 of FIG. 1). Operations 1000 may be implemented as software components that are executed and run on one or more processors (e.g., controller/processor 240/280 of FIG. 2). Further, the transmission and reception of signals in operations 1000 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1000 may begin, at block 1005, by sensing, by a first user equipment (UE) of a plurality of UEs, a frequency band to determine whether the frequency band is idle, the sensing occurring prior to a first time period.

In certain aspects, the operations 1000 may proceed to block 1010 by transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

In certain aspects, the one or more signals prevent the one or more other wireless devices from communicating on the frequency band during the first time period.

In certain aspects, a signal strength of the one or more signals indicates to the one or more other wireless devices that the frequency band is busy during the first time period.

In certain aspects, the operations 1000 further comprise randomly generating a number within a range of numbers; determining whether the randomly generated number satisfies a threshold value; and wherein the transmitting is performed by the first UE based on the randomly generated number satisfying the threshold value.

In certain aspects, operations 1000 further comprise calculating, by the first UE, the threshold value based on one or more operational parameters of the first UE including one or more of: a number of times the first UE has previously transmitted the one or more signals for one or more previous time periods, a number of data transmissions previously scheduled for the first UE to transmit during the first time period, or a local interference activity level sensed by the first UE.

In certain aspects, operations 1000 further comprise receiving, by the first UE from a second UE of the plurality of UEs, one or more operational parameters of the second UE, wherein the calculating the threshold value further comprises calculating the threshold value based on the one or more operational parameters of the first UE and the one or more operational parameters of the second UE.

In certain aspects, operations 1000 further comprise determining that the first UE belongs to a first group of a plurality of groups, each of the plurality of groups comprising one or more of the plurality of UEs, wherein the transmitting is performed by the first UE based on the first group being associated with the first time period.

In certain aspects, the determining that the first UE belongs to the first group comprises: randomly selecting, by the first UE, the first group from the plurality of groups; receiving, by the first UE from a second UE of the plurality of UEs, an indication that the first UE belongs to the first group; or selecting, by the first UE, the first group based on one or more operational parameters of the first UE.

In certain aspects, the one or more signals comprise one or more of a data transmission or a reservation signal.

In certain aspects, operations 1000 further comprise performing, by the first UE, a selection process prior to the first time period, the selection process determining whether to select the first UE to transmit the one or more signals over the frequency band during the first time period, wherein transmitting the one or more signals over the frequency band is based on the first UE being selected by the selection process for the first time period.

In certain aspects, operations 1000 further comprise wirelessly communicating, by the first UE with the plurality of UEs, over the frequency band during a plurality of time periods including the first time period; and determining, by the first UE, one or more time periods of the plurality of time periods for which to perform the selection process.

In certain aspects, operations 1000 further comprise receiving, by the first UE from a second UE of the plurality of UEs, one or more operational parameters of the second UE; determining, by the first UE, that the second UE belongs to a first group of a plurality of groups, each of the plurality of groups comprising one or more of the plurality of UEs, the determining based on the one or more operational parameters of the second UE; and transmitting, by the first UE to the second UE, an indication that the second UE belongs to the first group.

In certain aspects, the frequency band comprises a sidelink in an unlicensed spectrum.

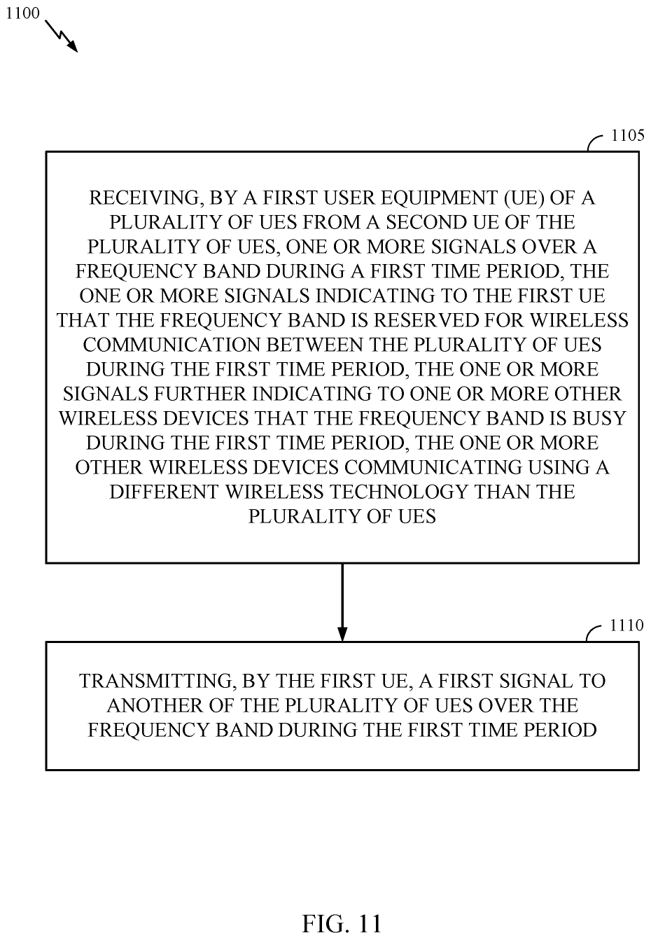

FIG. 11 is a flow diagram illustrating example operations 1100 for wireless communication, in accordance with certain aspects of the present disclosure. The operations 1100 may be performed, for example, by a UE (e.g., such as the UE 120a or UE 120b in the wireless communication network 100 of FIG. 1). Operations 1100 may be implemented as software components that are executed and run on one or more processors (e.g., controller/processor 240/280 of FIG. 2). Further, the transmission and reception of signals in operations 1100 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1100 may begin, at block 1105, by receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

The operations 1100 may proceed, at block 1110, by transmitting, by the first UE, a first signal to another of the plurality of UEs over the frequency band during the first time period.

In certain aspects, the one or more signals prevent the one or more other wireless devices from communicating on the frequency band during the first time period.

In certain aspects, a signal strength of the first signal and each of the one or more signals indicates to the one or more other wireless devices that the frequency band is busy during the first time period.

In certain aspects, the first signal and each of the one or more signals comprise one of a data transmission or a reservation signal.

In certain aspects, operations 1100 further comprise wirelessly communicating, by the first UE, with the plurality of UEs over the frequency band during a plurality of time periods including the first time period.

In certain aspects, the first time period is one of an entire time window for wireless communication by the plurality of UEs, or a portion of the entire time window.

In certain aspects, the frequency band comprises a sidelink in an unlicensed spectrum.

In certain aspects, the sidelink is used for vehicle to everything communication.

In certain aspects, the first time period is one of a plurality of time periods, each of the plurality of time periods occurring periodically.

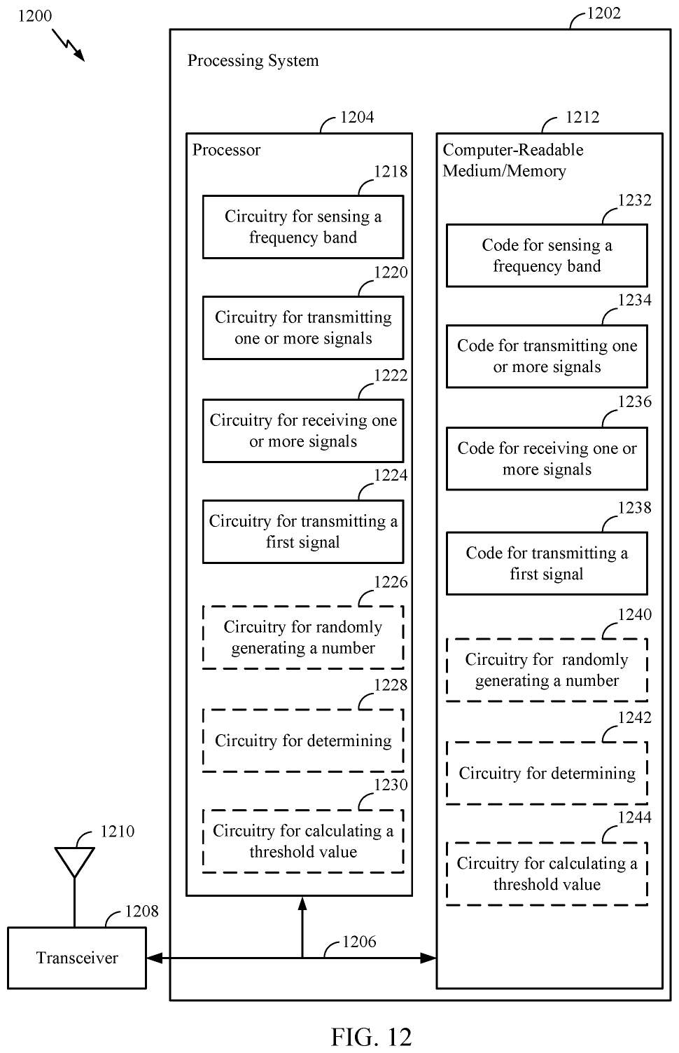

FIG. 12 illustrates a communications device 1200 that may include various components (e.g., corresponding to means-plus-function components) configured to perform operations for the techniques disclosed herein, such as the operations illustrated in FIGS. 10 and 11. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIGS. 10 and 11, or other operations for performing the various techniques discussed herein for performing sidelink communications in unlicensed bands.

In certain aspects, computer-readable medium/memory 1212 stores code 1232 for sensing, by a first user equipment (UE) of a plurality of UEs, a frequency band to determine whether the frequency band is idle, the sensing occurring prior to a first time period.

In certain aspects, computer-readable medium/memory 1212 stores code 1234 for transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

In certain aspects, computer-readable medium/memory 1212 stores code 1236 for receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

In certain aspects, computer-readable medium/memory 1212 stores code 1238 for transmitting, by the first UE, a first signal to another of the plurality of UEs over the frequency band during the first time period.

In certain aspects, computer-readable medium/memory 1212 stores code 1240 for randomly generating a number within a range of numbers.

In certain aspects, computer-readable medium/memory 1212 stores code 1242 for determining whether the randomly generated number satisfies a threshold value.

In certain aspects, computer-readable medium/memory 1212 stores code 1244 for calculating, by the first UE, the threshold value based on one or more operational parameters of the first UE including one or more of: a number of times the first UE has previously transmitted the one or more signals for one or more previous time periods, a number of data transmissions previously scheduled for the first UE to transmit during the first time period, or a local interference activity level sensed by the first UE.

Although not specifically shown in FIG. 12, in certain aspects, the computer-readable medium/memory 1212 stores code for receiving, by the first UE from a second UE of the plurality of UEs, one or more operational parameters of the second UE, wherein the calculating the threshold value further comprises calculating the threshold value based on the one or more operational parameters of the first UE and the one or more operational parameters of the second UE.

Although not specifically shown in FIG. 12, in certain aspects, the computer-readable medium/memory 1212 stores code for determining that the first UE belongs to a first group of a plurality of groups, each of the plurality of groups comprising one or more of the plurality of UEs, wherein the transmitting is performed by the first UE based on the first group being associated with the first time period.

Although not specifically shown in FIG. 12, in certain aspects, the computer-readable medium/memory 1212 stores code for randomly selecting, by the first UE, the first group from the plurality of groups; receiving, by the first UE from a second UE of the plurality of UEs, an indication that the first UE belongs to the first group; or selecting, by the first UE, the first group based on one or more operational parameters of the first UE.

Although not specifically shown in FIG. 12, in certain aspects, the computer-readable medium/memory 1212 stores code for performing, by the first UE, a selection process prior to the first time period, the selection process determining whether to select the first UE to transmit the one or more signals over the frequency band during the first time period, wherein transmitting the one or more signals over the frequency band is based on the first UE being selected by the selection process for the first time period.

Although not specifically shown in FIG. 12, in certain aspects, the computer-readable medium/memory 1212 stores code for wirelessly communicating, by the first UE with the plurality of UEs, over the frequency band during a plurality of time periods including the first time period; and determining, by the first UE, one or more time periods of the plurality of time periods for which to perform the selection process.

Although not specifically shown in FIG. 12, in certain aspects, the computer-readable medium/memory 1212 stores code for receiving, by the first UE from a second UE of the plurality of UEs, one or more operational parameters of the second UE; determining, by the first UE, that the second UE belongs to a first group of a plurality of groups, each of the plurality of groups comprising one or more of the plurality of UEs, the determining based on the one or more operational parameters of the second UE; and transmitting, by the first UE to the second UE, an indication that the second UE belongs to the first group.

In certain aspects, the processor 1204 has circuitry configured to implement the code stored in the computer-readable medium/memory 1212. The processor 1204 includes circuitry 1218 for sensing, by a first user equipment (UE) of a plurality of UEs, a frequency band to determine whether the frequency band is idle, the sensing occurring prior to a first time period.

In certain aspects, the processor 1204 has circuitry 1220 for transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

In certain aspects, the processor 1204 has circuitry 1222 for receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

In certain aspects, the processor 1204 has circuitry 1224 for transmitting, by the first UE, a first signal to another of the plurality of UEs over the frequency band during the first time period.

In certain aspects, the processor 1204 has circuitry 1226 for randomly generating a number within a range of numbers.

In certain aspects, the processor 1204 has circuitry 1228 for determining whether the randomly generated number satisfies a threshold value.

In certain aspects, the processor 1204 has circuitry 1230 for calculating, by the first UE, the threshold value based on one or more operational parameters of the first UE including one or more of: a number of times the first UE has previously transmitted the one or more signals for one or more previous time periods, a number of data transmissions previously scheduled for the first UE to transmit during the first time period, or a local interference activity level sensed by the first UE.

Although not specifically shown in FIG. 12, in certain aspects, the processor 1204 has circuitry for receiving, by the first UE from a second UE of the plurality of UEs, one or more operational parameters of the second UE, wherein the calculating the threshold value further comprises calculating the threshold value based on the one or more operational parameters of the first UE and the one or more operational parameters of the second UE.

Although not specifically shown in FIG. 12, in certain aspects, the processor 1204 has circuitry for determining that the first UE belongs to a first group of a plurality of groups, each of the plurality of groups comprising one or more of the plurality of UEs, wherein the transmitting is performed by the first UE based on the first group being associated with the first time period.

Although not specifically shown in FIG. 12, in certain aspects, the processor 1204 has circuitry for randomly selecting, by the first UE, the first group from the plurality of groups; receiving, by the first UE from a second UE of the plurality of UEs, an indication that the first UE belongs to the first group; or selecting, by the first UE, the first group based on one or more operational parameters of the first UE.

Although not specifically shown in FIG. 12, in certain aspects, the processor 1204 has circuitry for performing, by the first UE, a selection process prior to the first time period, the selection process determining whether to select the first UE to transmit the one or more signals over the frequency band during the first time period, wherein transmitting the one or more signals over the frequency band is based on the first UE being selected by the selection process for the first time period.

Although not specifically shown in FIG. 12, in certain aspects, the processor 1204 has circuitry for wirelessly communicating, by the first UE with the plurality of UEs, over the frequency band during a plurality of time periods including the first time period; and determining, by the first UE, one or more time periods of the plurality of time periods for which to perform the selection process.

Although not specifically shown in FIG. 12, in certain aspects, the processor 1204 has circuitry for receiving, by the first UE from a second UE of the plurality of UEs, one or more operational parameters of the second UE; determining, by the first UE, that the second UE belongs to a first group of a plurality of groups, each of the plurality of groups comprising one or more of the plurality of UEs, the determining based on the one or more operational parameters of the second UE; and transmitting, by the first UE to the second UE, an indication that the second UE belongs to the first group.

For example, means for transmitting (or means for outputting for transmission) may include a transmitter unit 254 and/or antenna(s) 252 of the UE 120a illustrated in FIG. 2 and/or circuitry 1220 for transmitting one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs of the communication device 1200 in FIG. 12.

Means for transmitting may also include circuitry 1224 for transmitting a first signal to another of the plurality of UEs over the frequency band during the first time period of the communication device 1200 in FIG. 12.

Means for receiving (or means for obtaining) may include a receiver and/or antenna(s) 252 of the UE 120a illustrated in FIG. 2 and/or circuitry 1222 for receiving, from a second UE of a plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs of the communication device 1200 in FIG. 2.

Means for communicating may include a transmitter, a receiver or both. Means for generating, means for performing, means for determining, means for taking action, means for sensing a frequency band to determine whether the frequency band is idle, the sensing occurring prior to a first time period, and means for coordinating may include a processing system, which may include one or more processors, such as the receive processor 258, the transmit processor 264, the TX MIMO processor 266, and/or the controller/processor 280 of the UE 120a illustrated in FIG. 2, the circuitry 1218 for sensing, and/or the processing system 1202 of the communication device 1200 in FIG. 12.

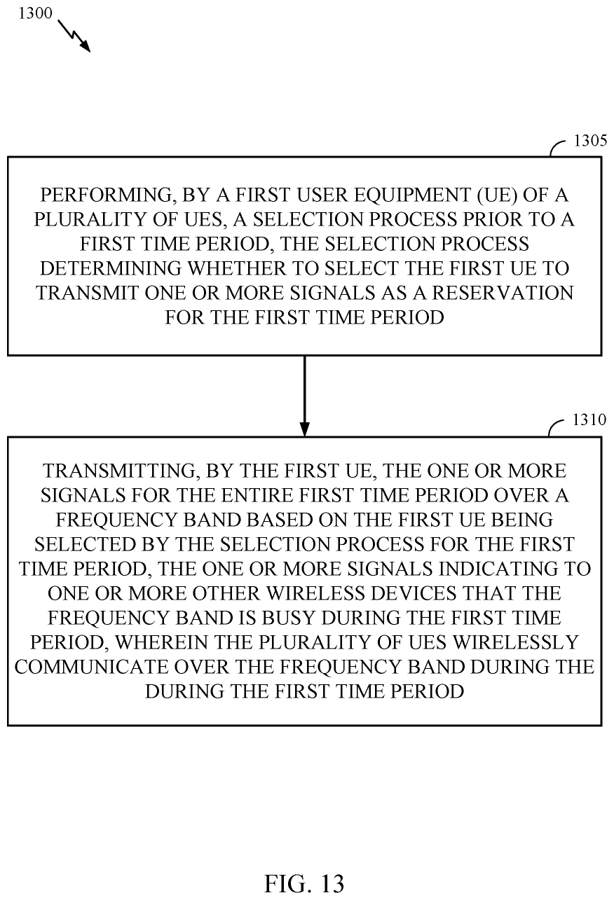

FIG. 13 is a flow diagram illustrating example operations 1300 for wireless communication, in accordance with certain aspects of the present disclosure. The operations 1300 may be performed, for example, by a UE (e.g., such as the UE 120a or UE 120b in the wireless communication network 100 of FIG. 1).

Operations 1300 may be implemented as software components that are executed and run on one or more processors (e.g., controller/processor 240/280 of FIG. 2). Further, the transmission and reception of signals in operations 1300 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1300 may begin, at block 1305, by performing, by a first user equipment (UE) of a plurality of UEs, a selection process prior to a first time period, the selection process determining whether to select the first UE to transmit one or more signals as a reservation for the first time period.

In certain aspects, the operations 1300 may proceed to block 1310 by transmitting, by the first UE, the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

In certain aspects, the one or more signals comprise one or more of a data transmission or a reservation signal.

In certain aspects, the selection process comprises: randomly generating a number within a range of numbers; determining whether the randomly generated number satisfies a threshold value; and based on the randomly generated number satisfying the threshold value, selecting the first UE for the first time period.

In certain aspects, the operations 1300 further comprising calculating, by the first UE, the threshold value based on one or more operational parameters of the first UE including one or more of: a number of times the first UE has previously been selected by the selection process for one or more previous time periods, a number of data transmissions already scheduled for the first UE to transmit during the first time period, or a local interference activity level measured by the first UE.

In certain aspects, operations 1300 further comprising receiving, by the first UE from a second UE of the plurality of UEs, one or more operational parameters of the second UE, wherein the calculating the threshold value further comprises calculating the threshold value based on the one or more operational parameters of the first UE and the one or more operational parameters of the second UE.

In certain aspects, receiving the one or more operational parameters of the second UE comprises receiving the one or more operational parameters of the second UE via a sidelink control channel in one of an unlicensed spectrum or a licensed spectrum.

In certain aspects, operations 1300 further comprising: determining that the first UE belongs to a first group of a plurality of groups, each of the plurality of groups comprising one or more of the plurality of UEs; and wherein the selection process selects the first UE for the first time period based on the first group corresponding to the first time period.

In certain aspects, the determining that the first UE belongs to the first group comprises: randomly selecting, by the first UE, the first group from the plurality of groups; receiving, by the first UE from a second UE of the plurality of UEs, an indication that the first UE belongs to the first group; or selecting, by the first UE, the first group based on one or more operational parameters of the first UE.

In certain aspects, operations 1300 further comprise: determining, by the first UE, that a second UE of the plurality of UEs belongs to a first group of a plurality of groups, each of the plurality of groups comprising one or more of the plurality of UEs, the determining based on operational parameters of the second UE; and transmitting, by the first UE to the second UE, an indication that the second UE belongs to the first group.

In certain aspects, the first time period is one of an entire time window for wireless communication by the plurality of UEs, or a portion of the time window.

In certain aspects, the first UE wirelessly communicates with the plurality of UEs over the frequency band during a plurality of time periods including the first time period, the method further comprising determining which of the plurality of time periods to perform the selection process for.

In certain aspects, the frequency band comprises a side link in an unlicensed spectrum.

In certain aspects, the side link is used for vehicle to everything communication.

In certain aspects, the first time period is one of a plurality of time periods, each of the plurality of time periods occurring periodically.

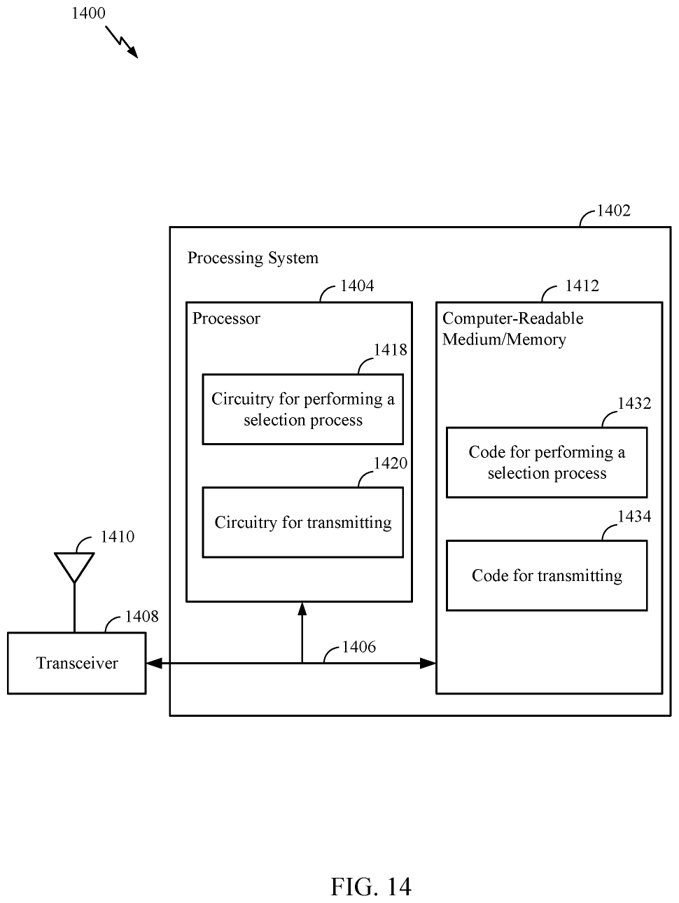

FIG. 14 illustrates a communications device 1400 that may include various components (e.g., corresponding to means-plus-function components) configured to perform operations for the techniques disclosed herein, such as the operations illustrated in FIG. 13. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 13, or other operations for performing the various techniques discussed herein for performing sidelink communications in unlicensed bands.

In certain aspects, computer-readable medium/memory 1412 stores code 1432 for transmitting a reservation signal within a first time period over multiple subchannels in a frequency band consisting of a plurality of subchannels, the reservation signal configured to indicate to any other wireless devices that the frequency band is busy during the first time period, wherein the frequency band is configured for wireless communication by the plurality of UEs during the first time period.

In certain aspects, computer-readable medium/memory 1412 stores code 1432 for performing, by a first user equipment (UE) of a plurality of UEs, a selection process prior to a first time period, the selection process determining whether to select the first UE to transmit one or more signals as a reservation for the first time period. In certain aspects, computer-readable medium/memory 1412 stores code 1434 for transmitting, by the first UE, the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

In certain aspects, the processor 1404 has circuitry configured to implement the code stored in the computer-readable medium/memory 1412. The processor 1404 includes circuitry 1418 for performing, by a first user equipment (UE) of a plurality of UEs, a selection process prior to a first time period, the selection process determining whether to select the first UE to transmit one or more signals as a reservation for the first time period.

In certain aspects, the processor 1404 has circuitry 1420 for transmitting, by the first UE, the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

For example, means for transmitting (or means for outputting for transmission) may include a transmitter unit 254 and/or antenna(s) 252 of the UE 120a illustrated in FIG. 2 and/or circuitry 1420 for transmitting the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period of the communication device 1400 in FIG. 14.

Means for receiving (or means for obtaining) may include a receiver and/or antenna(s) 252 of the UE 120a illustrated in FIG. 2 and/or transceiver 1408 and antenna 1410 in FIG. 14. Means for communicating may include a transmitter, a receiver or both. Means for generating, means for performing a selection process prior to a first time period, the selection process determining whether to select the first UE to transmit one or more signals as a reservation for the first time period, means for determining, means for taking action, means for determining, means for coordinating may include a processing system, which may include one or more processors, such as the receive processor 258, the transmit processor 264, the TX MIMO processor 266, and/or the controller/processor 280 of the UE 120a illustrated in FIG. 2 and/or the processing system 1418 of the communication device 1400 in FIG. 14.

### EXAMPLE ASPECTS

Aspect 1: A method of wireless communication, comprising: sensing, by a first user equipment (UE) of a plurality of UEs, a frequency band to determine whether the frequency band is idle, the sensing occurring prior to a first time period; and transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

Aspect 2: The method of Aspect 1, wherein the one or more signals prevent the one or more other wireless devices from communicating on the frequency band during the first time period.

Aspect 3: The method of Aspects 1 or 2, wherein a signal strength of the one or more signals indicates to the one or more other wireless devices that the frequency band is busy during the first time period.

Aspect 4: The method of any of Aspects 1-3, further comprising: randomly generating a number within a range of numbers; determining whether the randomly generated number satisfies a threshold value; and wherein the transmitting is performed by the first UE based on the randomly generated number satisfying the threshold value.

Aspect 5: The method of any of Aspects 1-4, further comprising calculating, by the first UE, the threshold value based on one or more operational parameters of the first UE including one or more of: a number of times the first UE has previously transmitted the one or more signals for one or more previous time periods, a number of data transmissions previously scheduled for the first UE to transmit during the first time period, or a local interference activity level sensed by the first UE.

Aspect 6: The method of any of Aspects 1-5, further comprising receiving, by the first UE from a second UE of the plurality of UEs, one or more operational parameters of the second UE, wherein the calculating the threshold value further comprises calculating the threshold value based on the one or more operational parameters of the first UE and the one or more operational parameters of the second UE.

Aspect 7: The method of any of Aspects 1-6, further comprising determining that the first UE belongs to a first group of a plurality of groups, each of the plurality of groups comprising one or more of the plurality of UEs, wherein the transmitting is performed by the first UE based on the first group being associated with the first time period.

Aspect 8: The method of any of Aspects 1-7, wherein the determining that the first UE belongs to the first group comprises: randomly selecting, by the first UE, the first group from the plurality of groups; receiving, by the first UE from a second UE of the plurality of UEs, an indication that the first UE belongs to the first group; or selecting, by the first UE, the first group based on one or more operational parameters of the first UE.

Aspect 9: The method of any of Aspects 1-8, wherein the one or more signals comprise one or more of a data transmission or a reservation signal.

Aspect 10: The method of any of Aspects 1-9, further comprising performing, by the first UE, a selection process prior to the first time period, the selection process determining whether to select the first UE to transmit the one or more signals over the frequency band during the first time period, wherein transmitting the one or more signals over the frequency band is based on the first UE being selected by the selection process for the first time period.

Aspect 11: The method of any of Aspects 1-10, further comprising: wirelessly communicating, by the first UE with the plurality of UEs, over the frequency band during a plurality of time periods including the first time period; and determining, by the first UE, one or more time periods of the plurality of time periods for which to perform the selection process.

Aspect 12: The method of any of Aspects 1-11, further comprising: receiving, by the first UE from a second UE of the plurality of UEs, one or more operational parameters of the second UE; determining, by the first UE, that the second UE belongs to a first group of a plurality of groups, each of the plurality of groups comprising one or more of the plurality of UEs, the determining based on the one or more operational parameters of the second UE; and transmitting, by the first UE to the second UE, an indication that the second UE belongs to the first group.

Aspect 13: The method of any of Aspects 1-12, wherein the frequency band comprises a sidelink in an unlicensed spectrum.

Aspect 14: A user equipment (UE) comprising a memory and one or more processors configured to perform the method of one or more of Aspects 1-13.

Aspect 15: A user equipment (UE) comprising: one or more means for performing the method of one or more of Aspects 1-13.

Aspect 16: A non-transitory computer-readable storage medium having instructions stored thereon that when executed by a user equipment (UE), cause the UE to perform the method of one or more of Aspects 1-13.

Aspect 17: A method of wireless communication, comprising: receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs; and transmitting, by the first UE, a first signal to another of the plurality of UEs over the frequency band during the first time period.

Aspect 18: The method of Aspect 17, wherein the one or more signals prevent the one or more other wireless devices from communicating on the frequency band during the first time period.

Aspect 19: The method of Aspects 17 or 18, wherein a signal strength of the first signal and each of the one or more signals indicates to the one or more other wireless devices that the frequency band is busy during the first time period.

Aspect 20: The method of one or more of Aspects 17-19, wherein the first signal and each of the one or more signals comprise one of a data transmission or a reservation signal.

Aspect 21: The method of one or more of Aspects 17-20, further comprising wirelessly communicating, by the first UE, with the plurality of UEs over the frequency band during a plurality of time periods including the first time period.

Aspect 22: The method of one or more of Aspects 17-21, wherein a second time period is after and continuous in time with the first time period, and wherein the second time period is for one of communication by the plurality of UEs or communication by the one or more other wireless devices.

Aspect 23: The method of one or more of Aspects 17-22 wherein the frequency band comprises a sidelink in an unlicensed spectrum.

Aspect 24: The method of one or more of Aspects 17-23, wherein the sidelink is used for vehicle to everything communication.

Aspect 25: The method of one or more of Aspects 17-24, wherein the first time period is one of a plurality of time periods, each of the plurality of time periods occurring periodically.

Aspect 26: A first user equipment (UE) of a plurality of UEs, comprising: a memory; and a processor coupled to the memory, the processor and the memory configured to: sense a frequency band to determine whether the frequency band is idle, the sensing occurring prior to a first time period; and transmit one or more signals over the frequency band during the first time period based on determining that the frequency band is idle, the one or more signals indicating to one or more other wireless devices, configured to communicate using a different wireless technology than the plurality of UEs, that the frequency band is busy during the first time period, the one or more signals further indicating that the frequency band is reserved for wireless communication between the plurality of UEs during the first time period.

Aspect 27: The first UE of Aspect 26, wherein the one or more signals prevent the one or more other wireless devices from communicating on the frequency band during the first time period.

Aspect 28: The first UE of one or more of Aspects 26 and 27, wherein a signal strength of the one or more signals indicates to the one or more other wireless devices that the frequency band is busy during the first time period.

Aspect 29: The first UE of one or more of Aspects 26-28, wherein the processor and the memory are further configured to: randomly generate a number within a range of numbers; determine whether the randomly generated number satisfies a threshold value; and wherein the transmission of the one or more signals is performed by the first UE based on the randomly generated number satisfying the threshold value.

Aspect 30: The first UE of one or more of Aspects 26-29, wherein the processor and the memory are further configured to calculate the threshold value based on one or more operational parameters of the first UE including one or more of: a number of times the first UE has previously transmitted the one or more signals for one or more previous time periods, a number of data transmissions previously scheduled for the first UE to transmit during the first time period, or a local interference activity level sensed by the first UE.

Aspect 31: The first UE of one or more of Aspects 26-30, wherein the processor and the memory are further configured to receive, from a second UE of the plurality of UEs, one or more operational parameters of the second UE, and wherein the processor and the memory, being configured to calculate the threshold value, are further configured to calculate the threshold value based on the one or more operational parameters of the first UE and the one or more operational parameters of the second UE.

Aspect 32: The first UE of one or more of Aspects 26-31, wherein the processor and the memory are further configured to determine that the first UE belongs to a first group of a plurality of groups, each of the plurality of groups comprising one or more of the plurality of UEs, wherein the transmission of the one or more signals is performed by the first UE based on the first group being associated with the first time period.

Aspect 33: A first user equipment (UE) of a plurality of UEs, comprising: a transceiver; a memory; and a processor coupled to the transceiver and the memory, the processor and the memory configured to: receive, from a second UE of the plurality of UEs, one or more signals over a frequency band during a first time period, the one or more signals indicating to one or more other wireless devices, configured to communicate using a different wireless technology than the plurality of UEs, that the frequency band is busy during the first time period, the one or more signals further indicating to the first UE that the frequency band is reserved for wireless communication between the plurality of UEs during the first time period; and transmit, by the first UE, a first signal over the frequency band to another of the plurality of UEs during the first time period.

Aspect 34: A method of wireless communication, comprising: performing, by a first user equipment (UE) of a plurality of UEs, a selection process prior to a first time period, the selection process determining whether to select the first UE to transmit one or more signals as a reservation for the first time period; and transmitting, by the first UE, the one or more signals for the entire first time period over a frequency band based on the first UE being selected by the selection process for the first time period, the one or more signals indicating to one or more other wireless devices that the frequency band is busy during the first time period, wherein the plurality of UEs wirelessly communicate over the frequency band during the during the first time period.

Aspect 35: The method of Aspect 34, wherein the one or more signals comprise one or more of a data transmission or a reservation signal.

Aspect 36: The method of Aspects 34 or 35, wherein the selection process comprises: randomly generating a number within a range of numbers; determining whether the randomly generated number satisfies a threshold value; and based on the randomly generated number satisfying the threshold value, selecting the first UE for the first time period.

Aspect 37: The method of any of Aspects 34-36, further comprising calculating, by the first UE, the threshold value based on one or more operational parameters of the first UE including one or more of: a number of times the first UE has previously been selected by the selection process for one or more previous time periods, a number of data transmissions already scheduled for the first UE to transmit during the first time period, or a local interference activity level measured by the first UE.

Aspect 38: The method of any of Aspects 34-37, further comprising receiving, by the first UE from a second UE of the plurality of UEs, one or more operational parameters of the second UE, wherein the calculating the threshold value further comprises calculating the threshold value based on the one or more operational parameters of the first UE and the one or more operational parameters of the second UE.

Aspect 39: The method of any of Aspects 34-38, wherein receiving the one or more operational parameters of the second UE comprises receiving the one or more operational parameters of the second UE via a sidelink control channel in one of an unlicensed spectrum or a licensed spectrum.

Aspect 40: The method of any of Aspects 34-39, further comprising: determining that the first UE belongs to a first group of a plurality of groups, each of the plurality of groups comprising one or more of the plurality of UEs; and wherein the selection process selects the first UE for the first time period based on the first group corresponding to the first time period.

Aspect 41: The method of any of Aspects 34-40, wherein the determining that the first UE belongs to the first group comprises: randomly selecting, by the first UE, the first group from the plurality of groups; receiving, by the first UE from a second UE of the plurality of UEs, an indication that the first UE belongs to the first group; or selecting, by the first UE, the first group based on one or more operational parameters of the first UE.

Aspect 42: The method of any of Aspects 34-41, further comprising: determining, by the first UE, that a second UE of the plurality of UEs belongs to a first group of a plurality of groups, each of the plurality of groups comprising one or more of the plurality of UEs, the determining based on operational parameters of the second UE; and transmitting, by the first UE to the second UE, an indication that the second UE belongs to the first group.

Aspect 42: The method of any of Aspects 34-41, wherein the first time period is one of an entire time window for wireless communication by the plurality of UEs, or a portion of the time window.

Aspect 43: The method of any of Aspects 34-42, wherein the first UE wirelessly communicates with the plurality of UEs over the frequency band during a plurality of time periods including the first time period, the method further comprising determining which of the plurality of time periods to perform the selection process for.

Aspect 44: The method of any of Aspects 34-43, wherein the frequency band comprises a side link in an unlicensed spectrum.

Aspect 45: The method of any of Aspects 34-44, wherein the side link is used for vehicle to everything communication.

Aspect 46: The method of any of Aspects 34-45, wherein the first time period is one of a plurality of time periods, each of the plurality of time periods occurring periodically.

Aspect 47: A user equipment (UE) comprising a memory and one or more processors configured to perform the method of one or more of Aspects 34-46.

Aspect 48: A user equipment (UE) comprising: one or more means for performing the method of one or more of Aspects 34-46.

Aspect 49: A non-transitory computer-readable storage medium having instructions stored thereon that when executed by a user equipment (UE), cause the UE to perform the method of one or more of Aspects 34-46.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

Within the present document, the term “user equipment (UE)” or “CV2X device” broadly refers to a diverse array of devices and technologies. UEs and CV2X devices may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a UE or CV2X device include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A UE or CV2X device may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A UE or CV2X device may additionally be a digital home or smart home device such as a home audio, video, and/or multimedia device, an appliance, a vending machine, intelligent lighting, a home security system, a smart meter, etc. A UE or CV2X device may additionally be a smart energy device, a security device, a solar panel or solar array, a municipal infrastructure device (e.g., a smart grid, public WiFi, etc.), an industrial automation and enterprise device, a logistics controller, agricultural equipment, military defense equipment: vehicles, aircraft, ships, and weaponry, etc. Still further, a UE or CV2X device may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

In some examples, access to the air interface may be scheduled. A scheduling entity (e.g., a BS) allocates resources for communication among some or all devices and equipment within its service area or cell. The scheduling entity may be responsible for scheduling, selecting, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise a non-transitory computer-readable medium (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 10, 11, and 13.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of wireless communication, comprising:
sensing, by a first user equipment (UE) of a plurality of UEs, a frequency band to determine whether the frequency band is idle, the sensing occurring prior to a first time period; and
transmitting, by the first UE, one or more signals over the frequency band during the first time period based on determining that the frequency band is idle, the one or more signals indicating that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs.

2. The method of claim 1, wherein the one or more signals prevent the one or more other wireless devices from communicating on the frequency band during the first time period.

3. The method of claim 1, wherein a signal strength of the one or more signals indicates to the one or more other wireless devices that the frequency band is busy during the first time period.

4. The method of claim 1, further comprising:
randomly generating a number within a range of numbers;
determining whether the randomly generated number satisfies a threshold value; and
wherein the transmitting is performed by the first UE based on the randomly generated number satisfying the threshold value.

5. The method of claim 4, further comprising calculating, by the first UE, the threshold value based on one or more operational parameters of the first UE including one or more of:
a number of times the first UE has previously transmitted the one or more signals for one or more previous time periods,
a number of data transmissions previously scheduled for the first UE to transmit during the first time period, or
a local interference activity level sensed by the first UE.

6. The method of claim 5, further comprising receiving, by the first UE from a second UE of the plurality of UEs, one or more operational parameters of the second UE, wherein the calculating the threshold value further comprises calculating the threshold value based on the one or more operational parameters of the first UE and the one or more operational parameters of the second UE.

7. The method of claim 1, further comprising determining that the first UE belongs to a first group of a plurality of groups, each of the plurality of groups comprising one or more of the plurality of UEs, wherein the transmitting is performed by the first UE based on the first group being associated with the first time period.

8. The method of claim 7, wherein the determining that the first UE belongs to the first group comprises:
randomly selecting, by the first UE, the first group from the plurality of groups;
receiving, by the first UE from a second UE of the plurality of UEs, an indication that the first UE belongs to the first group; or
selecting, by the first UE, the first group based on one or more operational parameters of the first UE.

9. The method of claim 1, wherein the one or more signals comprise one or more of a data transmission or a reservation signal.

10. The method of claim 1, further comprising performing, by the first UE, a selection process prior to the first time period, the selection process determining whether to select the first UE to transmit the one or more signals over the frequency band during the first time period, wherein transmitting the one or more signals over the frequency band is based on the first UE being selected by the selection process for the first time period.

11. The method of claim 10, further comprising:
wirelessly communicating, by the first UE with the plurality of UEs, over the frequency band during a plurality of time periods including the first time period; and
determining, by the first UE, one or more time periods of the plurality of time periods for which to perform the selection process.

12. The method of claim 1, further comprising:
receiving, by the first UE from a second UE of the plurality of UEs, one or more operational parameters of the second UE;
determining, by the first UE, that the second UE belongs to a first group of a plurality of groups, each of the plurality of groups comprising one or more of the plurality of UEs, the determining based on the one or more operational parameters of the second UE; and
transmitting, by the first UE to the second UE, an indication that the second UE belongs to the first group.

13. The method of claim 1, wherein the frequency band comprises a sidelink in an unlicensed spectrum.

14. A method of wireless communication, comprising:
receiving, by a first user equipment (UE) of a plurality of UEs from a second UE of the plurality of UEs, one or more signals over a frequency band during a first time period, the one or more signals indicating to the first UE that the frequency band is reserved for wireless communication between the plurality of UEs during the first time period, the one or more signals further indicating to one or more other wireless devices that the frequency band is busy during the first time period, the one or more other wireless devices communicating using a different wireless technology than the plurality of UEs; and
transmitting, by the first UE, a first signal to another of the plurality of UEs over the frequency band during the first time period.

15. The method of claim 14, wherein the one or more signals prevent the one or more other wireless devices from communicating on the frequency band during the first time period.

16. The method of claim 14, wherein a signal strength of the first signal and each of the one or more signals indicates to the one or more other wireless devices that the frequency band is busy during the first time period.

17. The method of claim 14, wherein the first signal and each of the one or more signals comprise one of a data transmission or a reservation signal.

18. The method of claim 14, further comprising wirelessly communicating, by the first UE, with the plurality of UEs over the frequency band during a plurality of time periods including the first time period.

19. The method of claim 14, wherein a second time period is after and continuous in time with the first time period, and wherein the second time period is for one of communication by the plurality of UEs or communication by the one or more other wireless devices.

20. The method of claim 14 wherein the frequency band comprises a sidelink in an unlicensed spectrum.

21. The method of claim 20, wherein the sidelink is used for vehicle to everything communication.

22. The method of claim 14, wherein the first time period is one of a plurality of time periods, each of the plurality of time periods occurring periodically.

23. A first user equipment (UE) of a plurality of UEs, comprising:
a memory; and
a processor coupled to the memory, the processor and the memory configured to:
sense a frequency band to determine whether the frequency band is idle, the sensing occurring prior to a first time period; and
transmit one or more signals over the frequency band during the first time period based on determining that the frequency band is idle, the one or more signals indicating to one or more other wireless devices, configured to communicate using a different wireless technology than the plurality of UEs, that the frequency band is busy during the first time period, the one or more signals further indicating that the frequency band is reserved for wireless communication between the plurality of UEs during the first time period.

24. The first UE of claim 23, wherein the one or more signals prevent the one or more other wireless devices from communicating on the frequency band during the first time period.

25. The first UE of claim 23, wherein a signal strength of the one or more signals indicates to the one or more other wireless devices that the frequency band is busy during the first time period.

26. The first UE of claim 23, wherein the processor and the memory are further configured to:
randomly generate a number within a range of numbers;
determine whether the randomly generated number satisfies a threshold value; and
wherein the processor and the memory, being configured to transmit one or more signals over the frequency band, are further configured to transmit the one or more signals based on the randomly generated number satisfying the threshold value.

27. The first UE of claim 26, wherein the processor and the memory are further configured to calculate the threshold value based on one or more operational parameters of the first UE including one or more of:
a number of times the first UE has previously transmitted the one or more signals for one or more previous time periods,
a number of data transmissions previously scheduled for the first UE to transmit during the first time period, or
a local interference activity level sensed by the first UE.

28. The first UE of claim 27, wherein the processor and the memory are further configured to receive, from a second UE of the plurality of UEs, one or more operational parameters of the second UE, and wherein the processor and the memory, being configured to calculate the threshold value, are further configured to calculate the threshold value based on the one or more operational parameters of the first UE and the one or more operational parameters of the second UE.

29. The first UE of claim 23, wherein the processor and the memory are further configured to determine that the first UE belongs to a first group of a plurality of groups, each of the plurality of groups comprising one or more of the plurality of UEs, and wherein the processor and the memory, being configured to transmit one or more signals over the frequency band, are further configured to transmit the one or more signals based on the first group being associated with the first time period.

30. A first user equipment (UE) of a plurality of UEs, comprising:
a memory; and
a processor coupled to the memory, the processor and the memory are configured to:
receive, from a second UE of the plurality of UEs, one or more signals over a frequency band during a first time period, the one or more signals indicating to one or more other wireless devices, configured to communicate using a different wireless technology than the plurality of UEs, that the frequency band is busy during the first time period, the one or more signals further indicating to the first UE that the frequency band is reserved for wireless communication between the plurality of UEs during the first time period; and
transmit, by the first UE, a first signal over the frequency band to another of the plurality of UEs during the first time period.
